(19) United States
(12) Patent Application Publication
(10) Pub. No.: US 2016/0107848 A1
(43) Pub. Date: Apr. 21, 2016

(54) SYSTEM AND METHOD FOR CREATING A STRUCTURED SET OF CONTAINERS

(71) Applicant: SODIUM LIMITED, Albana, Auckland (NZ)

(72) Inventor: John Russell BAKER, Onehunga, Auckland (NZ)

(21) Appl. No.: 14/892,742

(22) PCT Filed: May 21, 2014
(86) PCT No.: PCT/NZ2014/000091

§ 371 Date: Nov. 20, 2015

(30) Foreign Application Priority Data
May 21, 2013 (NZ) 610883
May 31, 2013 (NZ) 611384
Jul. 25, 2013 (NZ) 613608

(51) Int. Cl. B65G 60/00; B65G 61/00; B65G 1/137

(52) U.S. Cl. CPC B65G 60/00; B65G 1/1373; B65G 61/00

(57) ABSTRACT

A system for storing and retrieving a plurality of varieties of containers is disclosed. The system comprises a main conveyor (40), a main storage area for storing full stacks of containers (10) and conveying means for moving stacks of containers (2) from the main storage area (10) to the main conveyor (40). A second storage area (102) is provided for receiving full stacks from the main storage area (10) The second storage area (10) is configured to accommodate a stack of each variety of product. A gantry robot (72) is adapted to select one or more containers (2) from any stack of containers stored in the second storage area (102). The main conveyor (40) is provided with a container stacker (62) for stacking containers received from the gantry robot (72) into full stacks.

The present invention relates to apparatus, systems and methods for arranging stacks of containers, and in particular, but not exclusively, to the application of such apparatus, systems and methods to preparing structured sets of containers for delivery by a delivery vehicle.

### BACKGROUND TO THE INVENTION

The term “order picking” has become associated with systems designed for receiving, storing and delivering product to and from some form of storage area. They may also use some form of warehouse management system for co-ordination of storage.

Products for distribution are often stored in a warehouse and retrieved therefrom for loading onto a vehicle for transport to customers. In an effort to increase the speed and efficiency of the storage and delivery system, apparatus for automated retrieval, or “picking”, of product from the storage space have been developed. This has represented a large advance in the efficiency of order picking systems, which traditionally heavily relied on manual handling. Further advantages of automated systems include reduced overall cost, increased accuracy and decreased risk of personal injury.

The applicant's co-pending International Application No. PCT/NZ2010/000175 describes a system which in which efficiency is promoted by moving and storing frames of product together wherever possible, and by moving full stacks of product wherever it is not possible to move entire frames, or where less than an entire frame is required. However, this system may not be optimal for every warehousing and distribution situation.

Distribution of highly perishable goods, for example bread based products, presents specific problems. In many cases the bread must be distributed to the retail outlet within a short period, for example one day, of its production. This means that there is minimal opportunity for storage of supplies of bread product from which an individual retailer's order can be picked.

A further complication is that the bakery may produce different types of bread throughout the day, meaning that a delivery vehicle which is to deliver at least one of the varieties baked at the end of the day's run cannot leave until that variety has been prepared.

One presently used way of organising bread products for delivery is as follows:
1. Orders are taken from each retailer on the route of a given delivery vehicle.
2. The orders for each type of bread are aggregated to calculate the total number of each type of bread product required to fulfil all the requirements of all the retailers being delivered to by the delivery vehicle.
3. Each vehicle has a designated “staging” area into which the required number of containers of each bread product is placed as they are produced.
4. Containers of product for each delivery are then selected from the product in the staging area and loaded into the delivery vehicle in the appropriate order. This process can be extremely time consuming, often taking hours.
5. The vehicle then delivers the orders to each retailer on the route.

A particular problem with the final selection process described above, is that a relatively large number of the containers which are to be delivered by a typical delivery vehicle (up to 30-40%), contain a plurality of types of bread. This reflects that fact that many retailers will require only a small number of certain types of bread product, often much less than an entire container full of any one variety.

The result of this is that many containers must be manually packed with the correct combination of different types of products (a process known as “picking”). Since there are so many different types of product available, selecting the correct combination can be a very time consuming job. In most situations, space is limited so the containers are packed into stacks in the staging area. This may often result in the picker (typically the driver of the delivery vehicle) needing to remove one or more containers from the top of a stack, in order to access an item from a container located in the middle of the stack. This repeated manual rearrangement of stacks of containers is a significant factor in the time required to perform the picking operation.

Another complication specific to distribution of bread products is the variety of products available. In some cases there may be more than 80 varieties of bread product manufactured. While the majority of bread delivered (in absolute numbers) is selected from a relatively small number of types of product, a significant proportion of the bread delivered comprises relatively small numbers of units selected from a large number of types of bread. Some varieties of product may be sold in very small numbers, and only to a relatively small subset of customers. In some cases, some customers may order only a single item of some types of product, and others none at all of that type.

The reference to any prior art in this specification is not, and should not be taken as, an acknowledgement or any form of suggestion that the prior art forms part of the common general knowledge in any country.

### OBJECT OF THE INVENTION

It is one object of the present invention to provide a system for creating a set of containers which will overcome or ameliorate problems with such systems at present.

It is an alternative object of the present invention to provide a method of creating a set of containers for delivery by a delivery means which will overcome or ameliorate problems with such methods at present.

It is an alternative object of the invention to provide a container stack configuring system which will overcome or ameliorate problems with such systems at present.

It is an alternative object of the invention to provide a container storage carousel which will overcome or ameliorate problems with such apparatus at present.

It is an alternative object of the invention to provide an item picking system which will overcome or ameliorate problems with such systems at present.

It is an alternative object of the invention to provide a system for storing and retrieving a plurality of varieties of containers which will overcome or ameliorate problems with such apparatus at present.

It is an alternative object of the invention to provide a useful choice.

Other objects of the present invention may become apparent from the following description, which is given by way of example only.

### SUMMARY OF THE INVENTION

According to one broad aspect of the present invention there is provided a system for storing and retrieving a plurality of varieties of containers comprising:
A main conveyor;
A main storage area for storing full stacks of containers;
Conveying means for moving stacks of containers from the main storage area to the main conveyor;
A second storage area for receiving full stacks from the main storage area, the second storage area configured to accommodate a stack of each variety of product;
A gantry robot adapted to select one or more containers from any stack of containers stored in the second storage area;
Wherein the main conveyor is provided with a container stacker for stacking containers received from the gantry robot into full stacks.
Preferably the main storage area is provided with a plurality of parallel, spaced-apart, support members adapted to support a base of the stacks of containers, and one or more moveable conveyors engageable with one or more containers supported by the support members to transport it or them longitudinally, wherein said one or more moveable conveyors is moveable transverse to said support members below said support members to enable selective engagement with containers positioned on said support members.
Preferably the spaced apart support members are arranged into two tiers, one of said tiers provided above the other.
Preferably the main storage area comprises an aisle space and the support members are arranged perpendicular to a longitudinal axis of the aisle space.
Preferably the support members are provided on both sides of the aisle space.
Preferably at least one of the moveable conveyors extends into the aisle space so as to be able to transport at least one stack of containers along the aisle space.
Preferably the second storage area is provided with a plurality of parallel spaced-apart second storage area support members adapted to support a base of the stacks of containers.
Preferably one or more second storage area moveable conveyors are provided which are engageable with one or more containers supported by the second storage area support members to transport it or them longitudinally, wherein said one or more second storage area moveable conveyors is moveable transverse to said second storage area support members below said second storage area support member to enable selective engagement with containers positioned on said second storage area support members.
Preferably the second storage area comprises an aisle space and the second storage area support members are arranged perpendicular to a longitudinal axis of the aisle space.
Preferably the second storage area support members are provided on both sides of the aisle space.
Preferably at least one of the moveable conveyors of the second storage area extends into the aisle space so as to be able to transport at least one stack of containers along the second storage area aisle space.
Preferably the second storage area aisle space is connected to the aisle of the main storage area.
Preferably the second storage area aisle space is collinear with the aisle space of the main storage area.
Preferably the second storage area is adjacent the main storage area.
According to a second aspect of the present invention there is provided a method of configuring a set of delivery state stacks of containers for delivery by a delivery means to fulfil a plurality of orders, the method comprising
I. receiving a plurality of initial state stacks of containers;
II. using containers from the initial state stacks to create a set of intermediate state stacks of containers, wherein the intermediate state stacks of containers are configured to allow creation of a set of final state stacks from the intermediate state stacks without removing containers from the intermediate state stacks non-sequentially;
III. creating a set of delivery state containers from the intermediate state stacks of containers.
   Preferably the method comprises the step of creating at least one intermediate state stack which comprises at least one container which contains a plurality of varieties of product.
   Preferably the method comprises storing the intermediate state stacks in a storage area between steps II and III.
   Preferably the method comprises creating intermediate state stacks which contain substantially every container required to create the entire set of delivery state stacks.
   Preferably the method comprises configuring a set of delivery state stacks of containers for delivery by a plurality of delivery means, wherein the intermediate state stacks for each said delivery means are grouped together in the storage area.

According to a third aspect of the present invention there is provided a system for configuring a set of delivery state stacks of containers for delivery by a delivery means to fulfil a plurality of orders, the system comprising:
a stack configuring subsystem for receiving a plurality of initial state stacks of containers and using containers from the initial state stacks to create a set of intermediate state stacks of containers, wherein the intermediate state stacks of containers are configured to allow creation of a set of final state stacks from the intermediate state stacks without removing containers from the intermediate state stacks non-sequentially; and
a storage area for storing the intermediate state stacks; wherein the intermediate state stacks are moved from the storage area back to the stack configuring subsystem and are reconfigured by the stack configuring subsystem into a set of delivery state containers.

Preferably the system comprises a unit picking subsystem adapted to create at least one unit pick item container which contains a plurality of varieties of product.

Preferably the stack configuring subsystem receives the at least one unit pick item container and creates at least one intermediate state stack comprising the at least one unit pick item container.

Preferably the picking subsystem receives containers from the stack configuring subsystem.

Preferably the system can configure sets of delivery state stacks of containers for delivery by a plurality of delivery means, wherein the intermediate state stacks for each respective delivery means are grouped together within the storage area when stored.

According to a fourth aspect of the present invention there is provided a system for creating a set of containers comprising;
a picking subsystem for filling picked item containers with required items, the picking subsystem comprising container storage means for storing a plurality of homogeneous variety containers from which individual items can be picked, wherein each homogeneous variety container holds a plurality of items of a single variety;
a storage area for storing stacks containing a required number of picked item containers and homogeneous variety containers;
a stack configuring subsystem for receiving picked item containers and homogeneous variety containers from the storage area and arranging the picked item containers and the homogeneous variety containers into stacks of containers having a required configuration;
wherein the stack configuring subsystem replenishes the picking subsystem container storage means by receiving stacks of homogeneous variety containers and transferring containers from the stacks received to the container storage means.

Preferably the system creates sets of containers for delivery by a plurality of delivery vehicles, and the containers for each delivery vehicle are stored together in the storage area.

Preferably the stack configuring subsystem comprises a stack configuring subsystem storage area for storing stacks of containers, at least one gantry robot adapted to retrieve selected containers from the stacks, and a conveyor for conveying the selected stacks to a container stacking apparatus.

Preferably the system further comprises a replenishment container stack configuring apparatus.

Preferably the replenishment container stack configuring apparatus comprises means for creating stacks of homogeneous variety containers having a required configuration.

Preferably the stack configuring subsystem replenishes the picking subsystem container storage means by receiving stacks of homogeneous variety containers from the replenishment container stack configuring apparatus and transferring containers from the stacks received to the container storage means.

Preferably the replenishment container stack configuring apparatus receives containers from a replenishment container storage zone.

Preferably the container storage zone contains substantially no more than one stack of any variety of product.

Preferably the picking subsystem comprises a container storage carousel comprising a plurality of container storage units rotatably connected to a support means which is rotatable about a substantially horizontal axis, each said storage unit comprising at least one container support means, wherein the rotational connection between the storage units and the support means is such that a container engaged, in use, with any of the container support means is supported in a predetermined orientation regardless of the rotational position of the support means.

Preferably the stack configuring subsystem comprises a main elongate conveyor, a plurality of container destacking apparatus positioned towards a first end of the conveyor and a plurality of container stacking apparatus positioned towards a distal end of the conveyor, the system adapted to receive a plurality of stacks of containers through the container destacking apparatus, move the containers along the main conveyor in a required order, and create new stacks of containers with the container stacking apparatus.

Preferably the system comprises a plurality of automatically guided vehicles for moving stacks of containers between the subsystems and the storage zones.

Preferably the system comprises a main storage area comprising a plurality of racks adapted to support stacks of containers.

Preferably the racks are adapted to hold stacks of containers on two levels.

Preferably the racks are arranged in pair of rows with an aisle between each said pair of rows.

Preferably the main storage area is provided with a robot associated with each aisle, the robot adapted to store a selected stack of containers in one of said racks, and to retrieve a selected stack of containers from the racks.

Preferably the main storage area comprises a first conveyor and a second conveyor, wherein the first and second conveyors extend along substantially the entire length of one side of the main storage area.

Preferable the first and second conveyors operate in opposite directions.

Preferably the main storage area is provided with a plurality of buffer conveyors, each said buffer conveyor provided at one end of a respective aisle.

According to a firth aspect of the present invention there is provided a method of creating a set of containers for delivery by a delivery means to fulfil a plurality of orders, wherein the orders are to be delivered in a predetermined sequence, the method comprising;
I. Determining a configuration of a plurality of delivery state stacks of containers required to fulfil the orders, wherein the delivery state stacks are arranged such that the containers making up the delivery state stacks are in the correct sequence for fulfilling the orders in the predetermined sequence;
II. Picking required individual items into containers to create one or more non-homogeneous variety containers required to fulfil the orders;
III. Creating stacks of containers comprising a required number of homogeneous variety containers and a required number of non-homogeneous variety containers, wherein each stack has containers arranged in a relative order which is consistent with the predetermined sequence of deliveries to be made by the delivery means;
IV. Creating the delivery state stacks using containers from the stacks formed in step III.

Preferably the method comprises the step of storing the stacks of containers created in step III in a storage area.

Preferably the method comprises receiving homogeneous stacks of containers from a container source and storing the homogenous stacks of containers in a container stack reconfiguring apparatus storage area.

Preferably the method comprises replenishing a pick zone with containers from the container stack reconfiguring apparatus storage area.

Preferably the method comprises moving the stacks of containers from the storage area to the container stack reconfiguring apparatus storage area prior to step IV.

Preferably the delivery means is a delivery vehicle.

According to a sixth aspect of the present invention there is provided a container stack configuring system comprising a plurality of container destacking apparatus, at least one container stacking apparatus, and conveying means connecting the destacking apparatus and the stacking apparatus, the system adapted to receive a plurality of stacks of containers through the container destacking apparatus, move the containers to the stacking apparatus in a required order, and create new stacks of containers with the container stacking apparatus.

Preferably, the container stack configuring system comprises a main elongate conveyor, wherein the container destacking apparatus are positioned towards a first end of the conveyor and the container stacking apparatus are positioned towards a distal end of the conveyor.

Preferably one or more of the container destacking apparatus is a container stacking/destacking apparatus.

Preferably one or more of the container stacking apparatus is a container stacking/destacking apparatus.

According to a further aspect of the present invention there is provided a container storage carousel comprising a plurality of container storage units rotatably connected to a support means which is rotatable about a substantially horizontal axis, each said storage unit comprising at least one container support means, wherein the rotational connection between the storage units and the support means is such that a container engaged, in use, with any of the container support means is supported in a predetermined orientation regardless of the rotational position of the support means.

Preferably the container is supported in a substantially upright orientation.

Preferably the connection between the container storage units and the support means is rotatable about a substantially horizontal axis.

Preferably each said container storage unit comprises a plurality of container support means.

Preferably each said container storage unit is adapted to support a plurality of containers.

Preferably each said container storage unit is adapted to support the containers in a plurality of vertically spaced apart rows.

According to a still further broad aspect of the present invention there is provided an item picking system comprising support means for supporting a plurality of containers to define at least one pick face, the support means provided with display means for indicating a container in the or each pick face from which an item is to be picked, and weighing means for weighing a picked item container into which the picked item is to be placed, to thereby confirm when the item has been picked.

Preferably the item picking system comprises detecting means for detecting which of the containers defining the pick face the item is removed from.

Preferably the detecting means comprise optical detecting means.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

According to a still further aspect of the present invention, a system and/or method of creating a set of containers is substantially as herein described, with reference to the accompanying drawings.

According to a still further aspect of the present invention, a system for storing and retrieving a plurality of varieties of containers substantially as herein described with reference to FIGS. 15 to 18, FIG. 19, FIG. 20, FIG. 21 or FIG. 22.

Further aspects of the invention, which should be considered in all its novel aspects, will become apparent from the following description given by way of example of possible embodiments of the invention.

### BRIEF DESCRIPTION OF THE FIGURES

FIG. 1 is a diagrammatic plan view of a delivery truck packed with stacks of crates for delivery to a plurality of locations.

FIG. 2 is a diagrammatic plan view of a structured set of containers in a staging area, ready for loading into the delivery vehicle.

FIG. 3 is a simplified diagrammatic plan view of a system for creating a structured set of containers.

FIG. 4 is a diagrammatic plan view of a picking subsystem of the system of FIG. 3.

FIG. 5 is a diagrammatic end view of the picking subsystem of FIG. 4.

FIG. 6 is a diagrammatic side view of the picking subsystem of FIG. 4.

FIG. 7 is an enlarged diagrammatic plan view of the unit picking and container stack configuring subsystems of the system of FIG. 3.

FIG. 8 is a diagrammatic plan view of a preferred container stacker/destacker for use with the system of FIG. 3.

FIG. 9 is a diagrammatic end view of the container stacker/destacker of FIG. 8.

FIG. 10 is a diagrammatic side view of the container stacker/destacker of FIG. 8.

FIG. 11 is a diagrammatic front view of a preferred container rack for use in the system of FIG. 3.

FIG. 12 is a front view of an embodiment of an Automatically Guided Cart (AGC) suitable for use with the system of FIG. 3.

FIG. 13 is a top view of the AGC of FIG. 12.

FIG. 14 is an enlarged diagrammatic plan view of the replenishment container storage zone of the system shown in FIG. 3.

FIG. 15 is a diagrammatic plan view of a second embodiment of a system for creating a structured set of containers.

FIG. 16 is a diagrammatic cross section through axis A, showing a side elevation of the stack configuring subsystem of the second embodiment.

FIG. 17 is a diagrammatic cross section through axis B, showing a side elevation of the main storage area of the second embodiment.

FIG. 18 is a diagrammatic cross section through axis C, showing a side elevation of the main storage area of the second embodiment.

FIG. 19 is a diagrammatic plan view of a third embodiment of a system for creating a structured set of containers.

FIG. 20 is a diagrammatic plan view of a fourth embodiment of a system for creating a structured set of containers.

FIG. 21 is a diagrammatic plan view of a fifth embodiment of a system for creating a structured set of containers, with most support rails not shown for clarity, and portions of the moveable conveyor which underlie the support rails shown in hidden detail.

FIG. 22 is a diagrammatic side view of a variation of the embodiment shown in FIG. 21.

### DEFINITIONS

“Container” refers to any unit for holding one or more items or products which can be stacked one on top of another, and includes, without limitation, crates, boxes, tins, cartons, cases, totes or a plurality of grouped containers, such as a pallet of containers or a group of bound containers. Unless otherwise stated, all containers within a system have the same exterior dimensions.
“Delivery state stack” Refers to a stack of containers which are in a configuration which is suitable for loading into a delivery vehicle, and so do not require any further modification before being sent to the staging area.
“Destacking” Removing one or more containers from a stack of containers.
“Homogeneous variety container” Means a container holding only one variety of product.
“Homogeneous stack” Means a stack of homogeneous containers, where all containers in the stack have the same variety of product.
“Item” Means a single unit of the product (for example a loaf of bread).
“Order” Unless the context requires otherwise, the term “order” means a request for a set of items or products comprising one or more varieties of products.
“Robot” Means a cartesian coordinate industrial robot, and unless the context clearly requires otherwise, excludes automatically guided vehicles.
“Stack” Means a plurality of containers, one on top of another.
“Staging area” Refers to an area in which delivery state stacks of containers are stored prior to loading.
“Unit pick item” Refers to an item of product required to fulfil a particular order, where the number of units of that item required to fulfil the order is one or more, but is less than the number of items held by a full container.

### BRIEF DESCRIPTION OF THE INVENTION

### Introduction

The present invention relates to the creation of sets of stacks of containers which, when loaded into a delivery vehicle in the correct order, are arranged so that the containers making up those stacks are in the correct sequence for fulfilling the orders associated with the destinations on that particular vehicle's delivery route. In this way, the containers designated for an order associated with a particular destination on the delivery route are those nearest the freight access point of the vehicle (e.g the main doors of the cargo area) when the vehicle arrives at that destination, with containers for the next delivery on the route being the next closest, and so on. Stacks of containers which are in a configuration which is suitable for loading into a delivery vehicle are referred to herein as being in a “delivery state”.

In a typical example, when the delivery vehicle leaves the warehouse the containers nearest the access point are those designated for the first delivery on the route. The containers next closest to the access point are those for the second delivery on the route, and so on. The containers furthest from the access point are those designated for the last delivery.

The products held by the containers may be selected from a variety of different products, and some containers may contain a mixture of varieties of product. The exact mixture of products in a particular container may be specifically selected for a particular order.

The present invention has particular application to products such as bread and milk. These products are typically stored in stackable containers, with each container usually holding multiple items of product. The stacks of containers typically intermesh to some degree when stacked, without the need for any additional operation or equipment to secure the containers together. This means that stacks of containers can be moved by transportation equipment which engages the lowermost container in the stack.

Prior to being loaded into the delivery vehicle, stacks of containers which are in a delivery state are stored in a staging area, which, in the systems of the prior art, is usually near or on the vehicle loading platform.

Configuration of Delivery State Stacks for Loading into the Delivery Vehicle

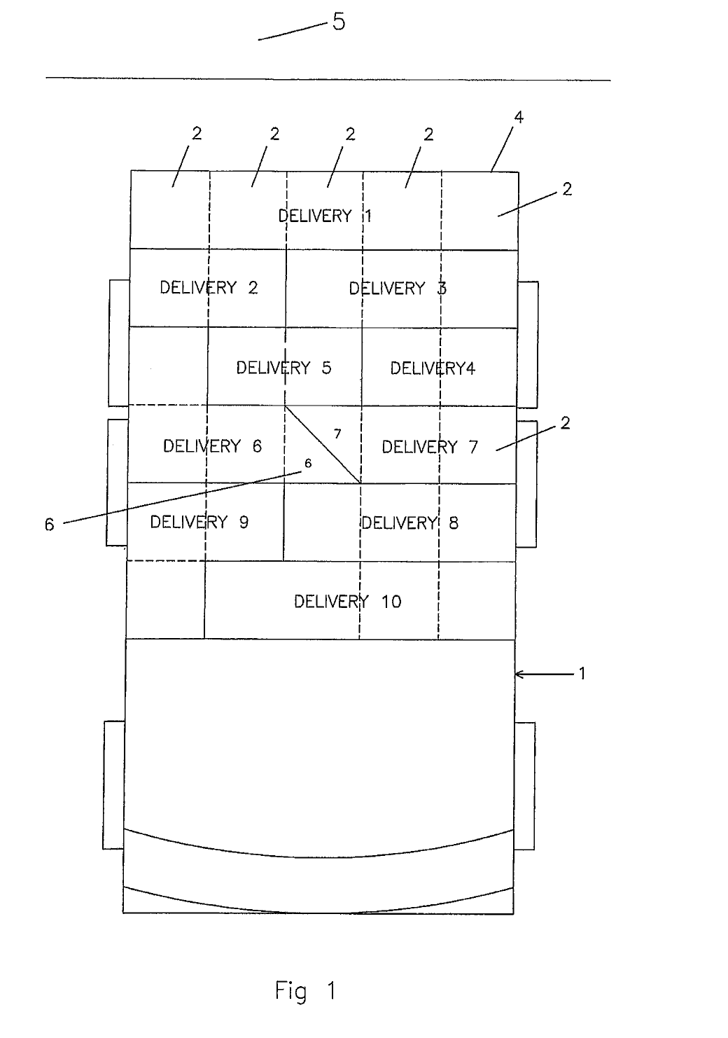

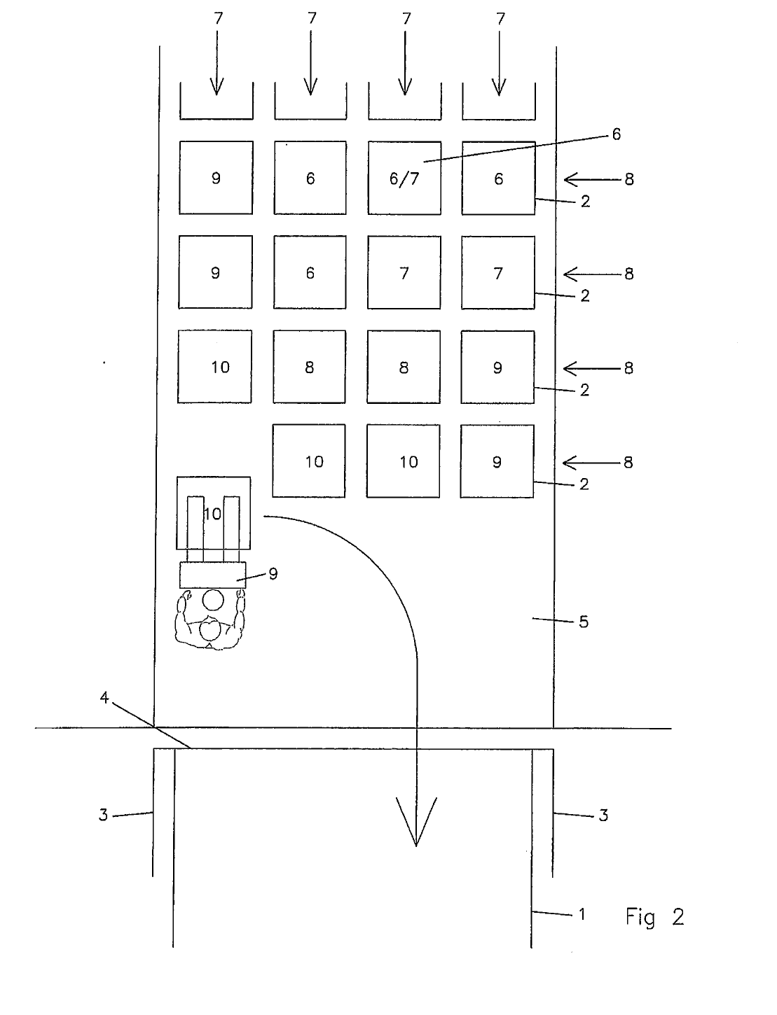

Referring next to FIGS. 1 and 2, a schematic diagram of a delivery vehicle 1 filled with stacks 2 of containers to fulfil a set of orders is shown. The delivery vehicle 1 has doors 3 at the rear 4 of the vehicle through which stacks 2 of containers are loaded and unloaded.

The stacks 2 are loaded from the staging area 5 into the vehicle 1. The containers in the staging area are arranged into stacks which are suitable for loading into the delivery vehicle 1 as shown. In the simplified embodiment shown, only one stack 6 includes containers intended for two different deliveries, in this case deliveries 6 and 7. In a preferred embodiment the containers of this mixed stack 6 which are intended for delivery no. 6 are placed on top of those intended for delivery no. 7.

As can be seen, when the truck is fully loaded, the containers required to fulfil delivery no. 1 are closest the doors 3 at the rear 4 of the vehicle 1. Once delivery no. 1 has been made, access is available to the containers for delivery no. 2 (and no. 3). Similarly, once the containers for delivery no. 3 have been delivered, the containers for delivery no. 4 are easily accessible, and so on.

For the stacks 2 to be loaded into the vehicle 1 in the configuration shown, they must be available to person loading the vehicle 1 in a suitable order. In theory the delivery state stacks 2 could be stored in a random configuration in the staging area 5, and the vehicle loader could identify the required stacks and place them in the correct order in the delivery vehicle 1. However, this either require a large amount of space (so that the loader could access whichever stack was required next) and/or would require the vehicle loader to move some delivery state stacks out of the way in order to gain access to a required delivery state stack. Neither of these options is efficient.

Another possibility is to arrange the delivery state stacks 2 in the staging area 5 in the exact order in which the need to be placed in the delivery vehicle 1. However, this is difficult to arrange, particularly when some of the product necessary to fulfil the orders only becomes available toward the end of the day (although some embodiments of the invention may be capable of structuring the delivery state stacks in this way).

Another method of arranging delivery state stacks in the staging area is shown in FIG. 2. Here, the delivery state stacks 2 are arranged into columns 7 and rows 8 across the staging area 5.

In the example shown there are four columns 7 of stacks 2, seven full rows 8 and one partial row (although only the first four rows 8 are shown in FIG. 2). Because of the way the columns 7 are arranged, it is not necessary to leave an aisle space between the columns 7.

As can be seen in FIG. 2, the columns 7 are arranged so that the relative order of the stacks in the column (from the front of the column to the back) is the same as the order in which the stacks 2 must be packed into the delivery vehicle 1. In the embodiment shown each stack 2 is destined for the same delivery, or an earlier delivery, as the stack immediately in front of it in the column 7 (the front of the columns 7 being the end of the column closest to the truck doors 3). In this way the delivery vehicle 1 can be loaded without the loader 9 ever needing to move a stack 2 of containers out of the way simply to access the stack behind it, and without needing to provide an aisle between the columns.

It will be appreciated that in some cases a stack 2 may be destined for a delivery which is the 2^{nd} or 3^{rd} delivery after the stack which is immediately in front of it in the column 7. There is no requirement for the stacks to be arranged strictly sequentially, as long as they are in the correct relative order.

A further possibility is that the staging area 5 may be remote from the vehicle loading area, and the system may supply stacks of delivery state containers from the staging area to a “handover” area where they are received by a human worker who moves them to the delivery vehicle.

### Overview of a First Embodiment of the Present Invention

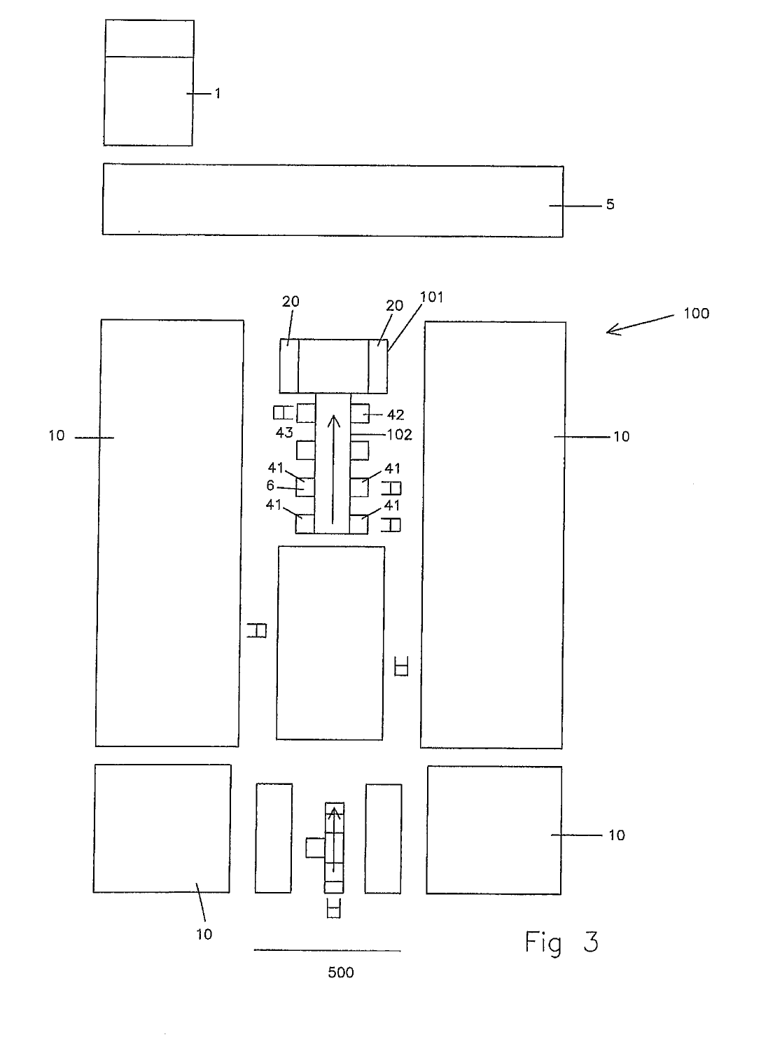

Referring next to FIG. 3, one embodiment of a system for creating a structured set of containers for loading into a delivery vehicle is generally referenced by arrow 100.

The system comprises a picking subsystem 101 and a stack configuring subsystem 102, described further below.

The system 100 shown in FIG. 3 operates in two distinct phases. In the first phase, containers are filled with “unit pick” items by the picking subsystem 101 described below. Stacks of unit pick item containers are created and stored in a storage area. Those skilled in the art will recognise that unit pick item containers are inherently non-homogeneous. Typically these stacks are not in a “delivery state”, although occasionally the system may recognise that a delivery state stack can be created relatively efficiently at this stage.

In the second phase, the stacks of unit pick item containers are fed into the stack configuring subsystem 102 along with stacks of homogenous containers. The unit pick containers are combined with the homogenous variety containers to create delivery state stacks. These delivery state stacks are then stored in a staging area 5 prior to being loaded onto a delivery vehicle 1 (as is described above).

During the first phase some of the stacks of unit pick items may be sent through the stack configuring subsystem 102 to modify the order of the containers in the stack to one which better promotes efficiency of the system 100 as a whole.

### Picking Subsystem

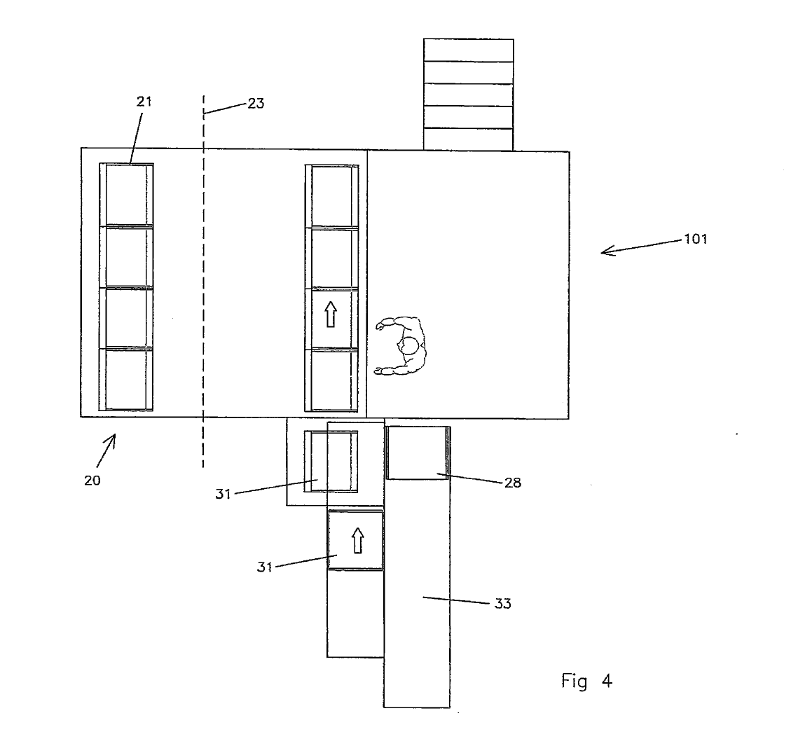

Referring next to FIGS. 3 to 7 in particular, the picking subsystem 101 comprises at least one container storage carousel 20. The carousel 20 comprises a plurality of container storage units 21 rotatably connected to a support means 22. The support means 22 is rotatable about a first horizontal rotational axis 23 by a suitable drive means such as an electric motor (not shown).

The container storage units 21 are rotatable relative to the support means 22 about respective second horizontal rotational axes 24, which are parallel to the first rotational axis 23. In a preferred embodiment the second rotatable connection 24 is towards the top of the units 21, or at least above a centre of gravity of the units 21, so that the container storage units 21 are self-levelling under the influence of gravity. However, in other embodiments a drive system (not shown) may be provided to maintain the orientation of the container storage units 21 regardless of the rotational position of the support means 22. The drive system may comprise, for example, an electric motor, a suitable cam based system, or a chain drive system.

Each container storage unit 21 comprises a plurality of container support means 25 such as shelves or suitable brackets. The support means 25 are adapted to hold a plurality of containers in spaced apart substantially parallel rows. In a preferred embodiment, the support means 25 comprise shelves, each shelf adapted to support four containers 26 side by side. In the embodiment shown, each unit 21 comprises five shelves, giving each container storage unit 21 the capacity to hold 20 containers.

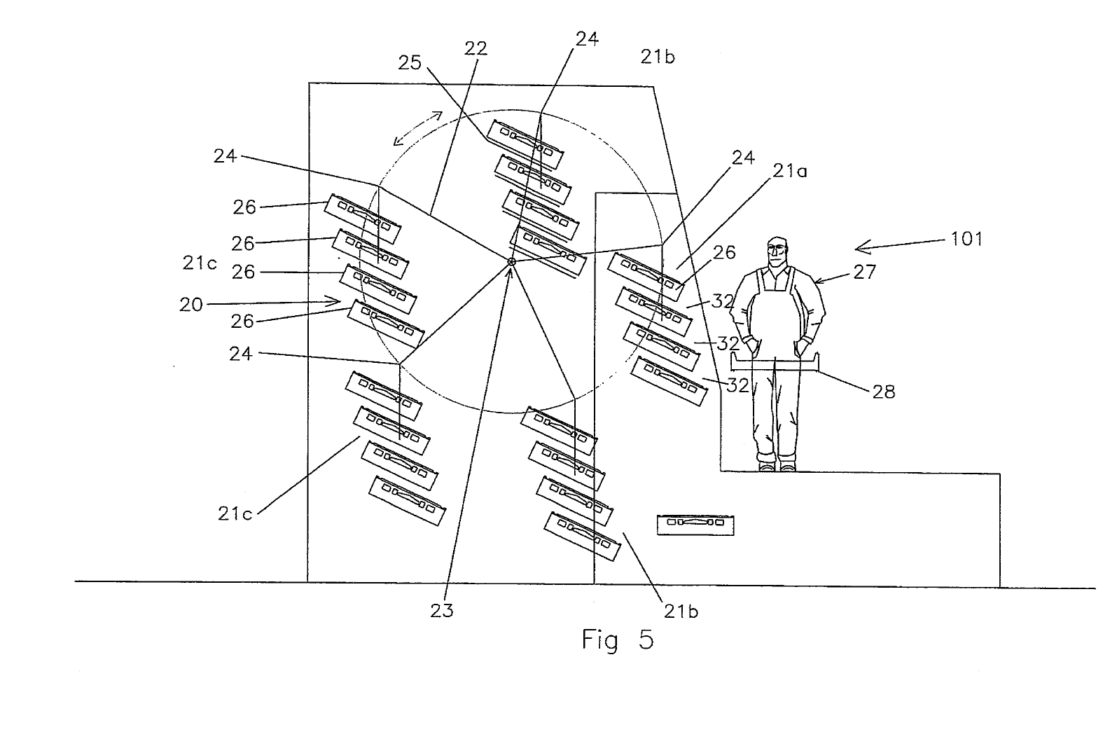

In use, the carousel 20 is rotatable between a number of predetermined angular positions, the number of positions corresponding to the number of container storage units 21 provided. In the embodiment shown with five container storage units 21, the carousel 20 has five rotational positions. Each position presents one of the five container storage units 21 in a suitable location for a picker 27 to access the containers 26 held by that shelving unit (best seen in FIG. 5). The vertical spacing between the container support means 24 is such that a picker 27 may access product from any one of the containers 26 held in the closest container storage unit 21 without needing to move the container.

A control means 200 controls rotation of the carousel 20 so that the container storage unit 21 containing the next item to be picked is positioned in front of the picker 27. In order to minimise any delay caused while the carousel 20 is rotating between the predetermined positions, the containers 26 are arranged such that those containers 26 most often required by the picker 27 are grouped together in one container storage unit 21a, with the next most frequently required containers in the two adjacent container storage units 21b, and the least frequently required containers in the next two adjacent container storage units 21c. In this way the majority of the picking actions can be performed with the carousel 20 needing to move between only three of the possible rotational positions.

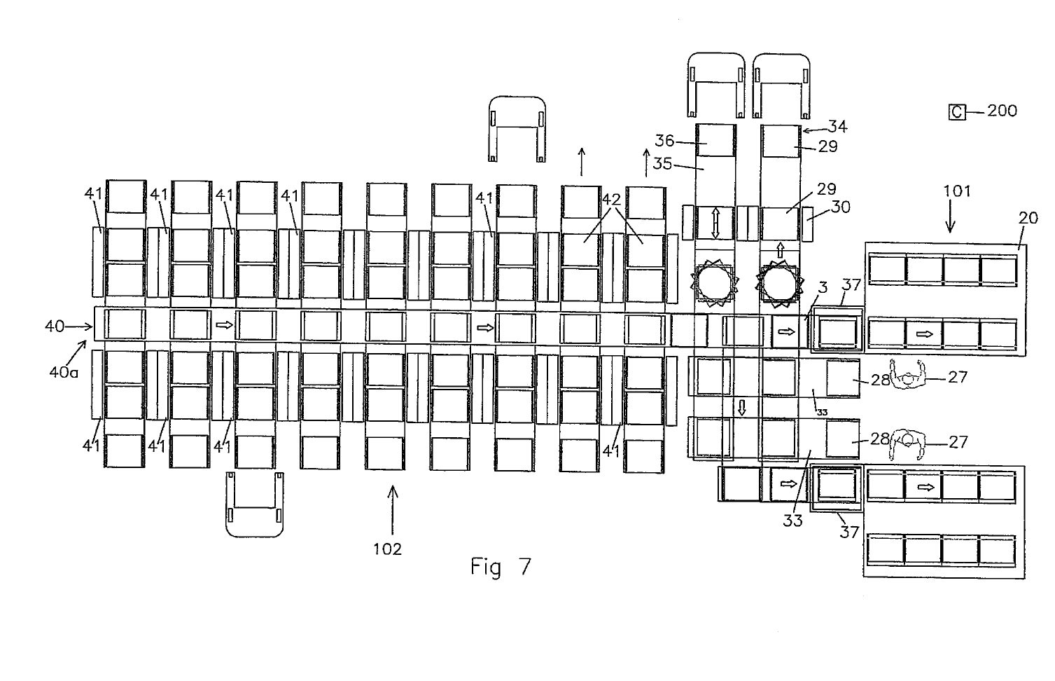

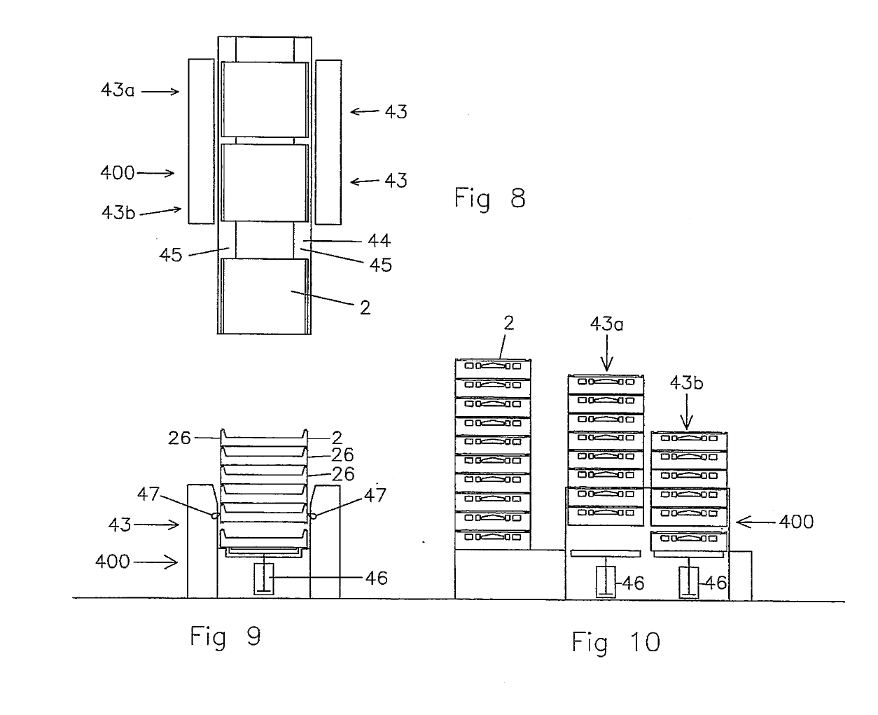

The picker 27 works under the direction of the control means 200 to fill a unit pick item container 28 with items. The full unit pick item containers 28 are collated together into a stack 29 by a suitable container stacking apparatus (“stacker”) 30 (shown in FIG. 7) in some embodiments of the invention. Suitable stacking apparatus are described further below with reference to FIGS. 8 to 10.

Each stack 29 from the picking subsystem 101 is destined for a particular delivery vehicle, and more preferably for a particular order. The stacks 29 comprise unit pick item containers 28, but may also contain some containers which contain only a single type of item (“homogeneous variety containers”).

The relative order of the containers in each stack 29 is preferably the same as, or opposite to, the relative order of the delivery which that container is intended to fulfil. That is, a) each container in a stack is intended for the same or a later delivery than the container above it, or, b) each container in a stack is intended for the same or an earlier delivery than the container above it. However, in some embodiments of the invention the stacks may be further processed at a later time, and so some slight deviation from this order may be allowed at this stage in order to optimise the running of the system.

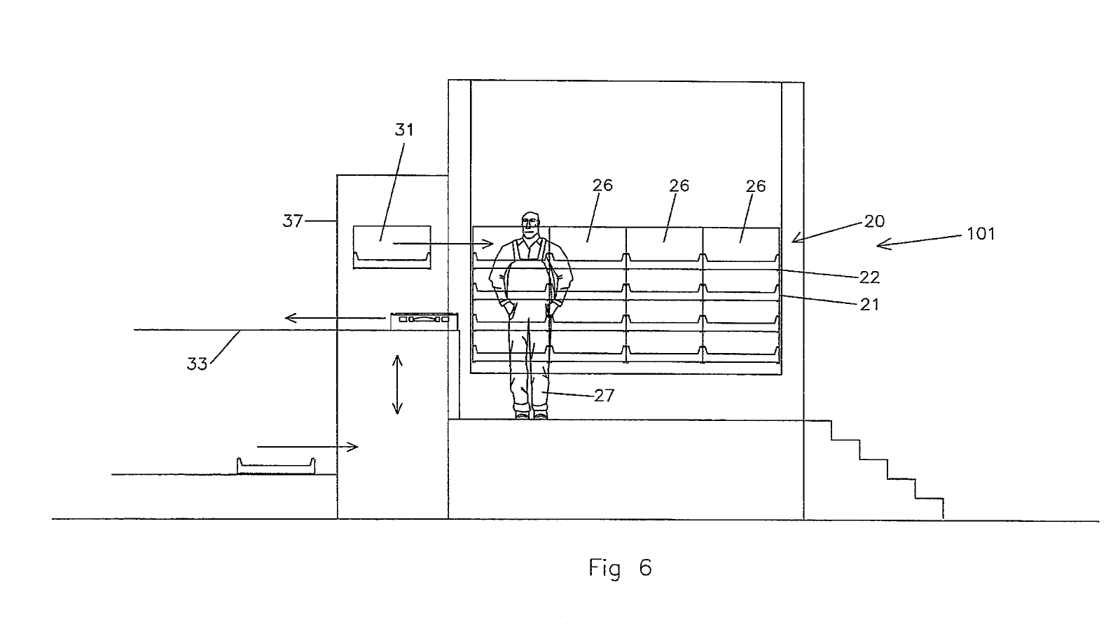

Each container storage unit 21 is preferably shaped and configured to allow full containers 31 to be loaded onto the support means 22 from one end of the support means 22, and to be pushed along the support means 22 in the longitudinal direction, as shown in FIG. 6.

In this embodiment the stack configuring system 102 is used to supply full containers of product to restock the support means 22 as required. In some embodiments the stack configuring system may be adapted to convey full containers directly to the support means 22 and may include lifting means 37 to lift the new container 31 to the height of the appropriate support means 21. In other embodiments the picker may manually lift the container and insert it into the space on the support means 22.

In a preferred embodiment the controller 200 communicates with the picker 27 to indicate which items are to be picked from the containers in the nearest container storage unit 21. In one embodiment visible signalling means such as a plurality of lights or LEDs 32 may be positioned to correspond with the position of each container 26. The control means 200 may activate the light 32 corresponding to the container 26 from which an item is to be selected. In some embodiments a digital readout may be provided to indicate how many items are to be taken from the container 26.

The picker 27 takes the selected item(s) from the container 26 indicated and places them in a unit pick item container 28 which is supported by a conveyor 33. When the container 28 has been filled (or at least contains all the items required by the order with which it is associated) the conveyor 33 moves it away to a pickup location 34 from which it can be moved to a storage area 10. In one embodiment the container 28 moves through a container stacker 29 before it is collected (as described above), and is only removed from the pickup location 34 once a full stack has been created. In one embodiment the container(s) are removed by an Automatically Guided Vehicle such as an Automatically Guided Cart (AGC), as is described further below.

In some cases the container stacker 30 may be able to stack the unit pick item containers 28 into a stack 29 which has a suitable configuration for storage in a staging area. However, in most cases the stack will not be in such a configuration, although it will be in a configuration which is suitable for entry into the stack configuring subsystem 102. In some embodiments two or more stacks 29 of unit pick item containers may be fed into the stack configuration subsystem 102 described below, in order to create reconfigured stacks of unit pick item containers 28 which are more convenient for integration into “delivery state” stacks, that is, stacks which are ready for loading into the delivery vehicle.

A conveyor 35 may be provided to supply new empty containers 36 for picking items into, and for removing and storing empty containers 36 which have been removed from the container storage units 21.

In some embodiments the picking subsystem 101 may be provided with means by which the controller 200 can confirm that a picked item has been taken from the correct container 26 and/or placed into the correct container 28. Such confirmation means may include weighing means such as a load cell provided underneath each support means in the carousel 20. The controller 200 may monitor the change in weight of the containers 26 to confirm that the correct number of items have been selected from a container 26 on that particular shelf.

In another embodiment a load cell may be provided beneath the picked item container 28, so that the system can confirm that the correct number of items have been placed in it. If required, a separate system may be used to confirm that the picked items have been taken from the correct container. In one embodiment this may take the form of an optical system which detects which container the picker's hand has reached over. Such a system may also be used to automatically stop rotation of the carousel if the picker moves too close to the carousel while it is moving.

In a preferred embodiment the control system 200 monitors the position of each item from its entry into the system 100 to the point at which it is delivered to the staging area 5 (and in some cases from the staging area into the delivery vehicle). Picking of items does not commence until the control system 200 determines that the carousel 20 holds all the items necessary to completely fill at least one unit pick item container 28 required by an order. This may mean that picking does not occur until sometime after production of the items has begun, and some containers of items may need to be stored in the storage area 10. However, picking of items may begin before production of the items has finished for the day. In this way the system 100 avoids the need for provision of sufficient storage space to store the entire day's production prior to the creation of the structured sets of containers, and the delay between production ending and the product being delivered is reduced.

### Stack Configuring Subsystem

Referring next to FIGS. 3 and 7, the stack configuring subsystem 102 comprises a plurality of destackers 41 connected by conveying means to at least one container stacker 42. In the embodiment shown the system 102 has a central main conveyor 40 and a plurality of container destackers 41. The main conveyor 40 preferably operates exclusively, or at least predominantly, in one direction.

The container destackers 41 are adapted to accept a stack 2 of containers 26 and to destack the containers 26 in order to place individual containers onto the main conveyor 40. At least one container stacker 42 is provided at the distal end of the conveyor 40. However, as is described further below, in preferred embodiments at least some of the container stackers 42 are also operable as destackers, if additional destackers are required to load containers onto the conveyor 40. In preferred embodiments each container stacker 42 is operable as a destacker 41 and vice versa. The terms “stacker” and “destacker” are used herein to indicate the minimum amount of functionality required by the apparatus referred to, and in most cases the apparatus referred to as a destacker will also be capable of operation as a stacker. This configuration gives the container configuring subsystem 102 increased flexibility, and also allows a single spare stacker/destacker unit to be used to replace any stacker 42 or destacker 41 in the system 102.

The container destackers 41 are may be positioned on either side of the main conveyor 40, or they may all be on the same side. In the embodiment shown nine stacker/destackers are provided on either side of the main conveyor.

### Description of Stacker/Destacker Units

A stacker/destacker apparatus 400 which is suitable for use as either a destacker 41 or a stacker 42 is shown in FIGS. 8 to 10.

The apparatus 400 comprises two separate stacking/destacking mechanisms 43 operable in series. A conveyor 44 moves stacks 2 of containers and individual containers towards or away from the stacking/destacking mechanisms as required.

The conveyor 44 comprises two parallel, spaced-apart belts or chains 45 which support the outside edges of the containers. Each stacking/destacking mechanism is provided with a lifting means 46 which extends through the space between the belts or chains 45 to lift a stack of containers 2, a partial stack, or a single container 26, which is located immediately above it. As best seen in FIG. 9, the mechanism 43 is provided with container engaging means 47 located above the conveyor 44. In some embodiments the engaging means 47 are at a sufficient height above the conveyor 43 that they may be controlled to engage with any required container in a stack 2 of containers 26, thereby dividing the stack at any required point. Selection of which container which is to be engaged by the engaging means 47 is determined by the distance the lifting means 46 has lifted the stack 2. Accordingly, the lifting means 46 must be capable of lifting the stack sufficiently high that the lowermost container in the stack can be engaged. However, in the embodiment shown, the engaging means 47 are at a height which allows engagement with the second-to-bottom container in the stack only. This may reduce the cost and size of the stacking/destacking mechanism.

The engaging means 46 may be of any suitable type, for example retractable tangs which engage with the bottom edge or the side wall of the container.

If the stacking/destacking apparatus 400 comprises only one stacking/destacking mechanism 43 (which may be preferred in some embodiments) then the order in which individual containers flow from the apparatus 400 to the conveyor 40 is determined by the order of the containers in the stack, that is, lowermost container first, followed by next lowermost, next lowermost, and so on. However, by providing two such mechanisms 43a, 43b in series (i.e., one after the other in respect of the conveyor 44), much greater flexibility is achieved. For example, the order of containers in a stack may be reversed by destacking the stack in the first of the mechanisms 43a and immediately restacking in the second mechanism 43b. Furthermore, both stacking/destacking mechanisms 43a, 43b may be filled or partially filled with containers. The containers may then be moved onto the conveyor 44 in a required order, for example, one container from the first mechanism 43a, two containers from the second mechanism 43b (one after the other), and so on. Those skilled in the art will appreciate that single containers 26 from the first mechanism 43a may pass under a stack of containers held by the engaging means 47 of the second mechanism 43b, and vice versa, thereby allowing selected containers from one mechanism 43a, 43b to move out of the stacking/destacking apparatus 400 ahead of containers from the other mechanism 43a, 43b.

In this embodiment, one end of the conveyor 44 is a loading/unloading point for an AGC, and the other is connected to the main conveyor 40, or to any other conveyor as required. However, in other embodiments, in particular when used as a stacker, the apparatus be configured to connect to conveyors at either end.

While the stacker/destacker 400 described above has two separate stacking/destacking mechanisms 43, any preferred number of separate stacking/destacking mechanisms 43 may be used.

### Storage of Stacks

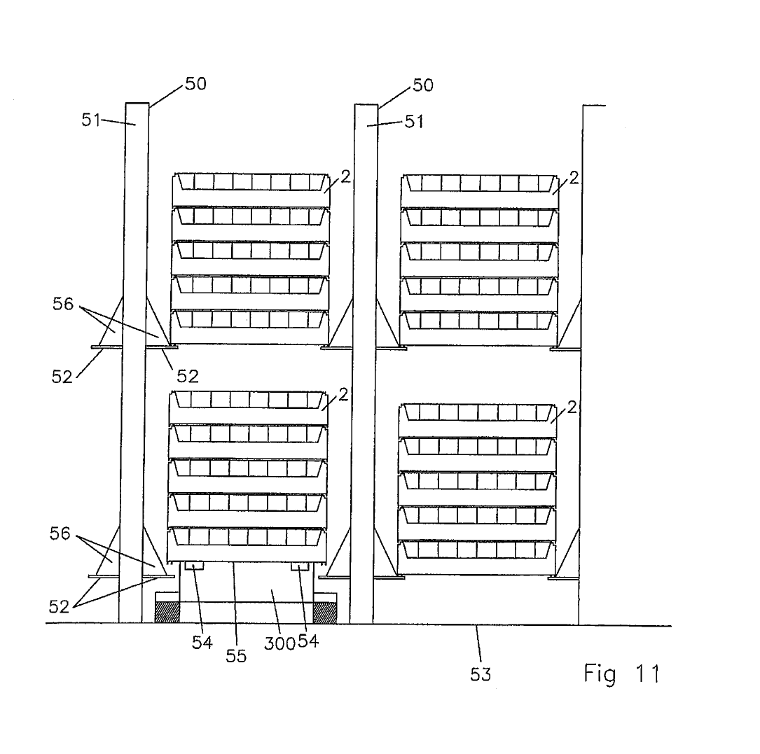

Referring next to FIGS. 3 and 11 in particular, in preferred embodiments items are placed into a bulk storage area after manufacture, while awaiting processing by the system 100. In some embodiments of the invention, unit pick item containers 28 may also be stored in the bulk storage area 100 (or a subspace within it), for example while awaiting further processing by the stack configuring subsystem 102.

In one embodiment the bulk storage area 10 comprises a plurality of racks 50 adapted to allow stacks 2 of containers 26 to be stored on two levels, one above the other.

The racks 50 preferably comprise substantially vertical support members 51 provided with inwardly facing container support means 52. The support means 52 are adapted to engage an outer edge of the base of the lowermost container in a stack 2, and to hold the stack 2 above the floor 53 at a height which allows a container engaging portion 54 of an AGC 300 (or gantry robot) to engage a base 55 of the lowermost container in a stack.

Each rack 50 may hold a plurality of stacks 2 on each of the two levels, with the space between the support members 51 and container support means 52 being sufficient for an AGC (or robot) to travel between the support members 51 and container support means 52 to store or retrieve containers from positions other than at the front of the rack 50.

By storing stacks 2 at two levels in this way, the footprint of the storage area 10 is greatly reduced. This method of storage has the additional advantage of allowing the AGC to lift a stack of containers by engaging the base of the lowermost container in the rack, rather than using an alternative arrangement which requires accurate indexing of the position of the AGC lifting means with a specific portion of the container. In the embodiment shown the container support means 52 has a sloping guide portion 56 which provides a self-centering action to the lowermost container in a stack, as the AGC lowers the stack onto the support means 52.

### AGCs

There are a number of options for configuring AGCs which are suitable for use with the system of the present invention.

In a preferred embodiment each AGC may be able to engage the lowermost container in a stack only.

However, in some embodiments the AGC may be able to grasp either the lowermost container or the second-to-bottom container in the stack. This design is able to destack the lower most container from the stack, and can, therefore, destack and stack entire stacks of containers, albeit in a relatively inefficient way.

In a further embodiment the AGC is capable of engaging any container in the stack, and so can break a single stack into two stacks of any size, and can create full stacks from partial stacks.

At the largest and most complex level, the AGC is capable of engaging any container in a stack and place the containers on top of another stack or partial stack. However, AGCs of this type may be relatively bulky and expensive.

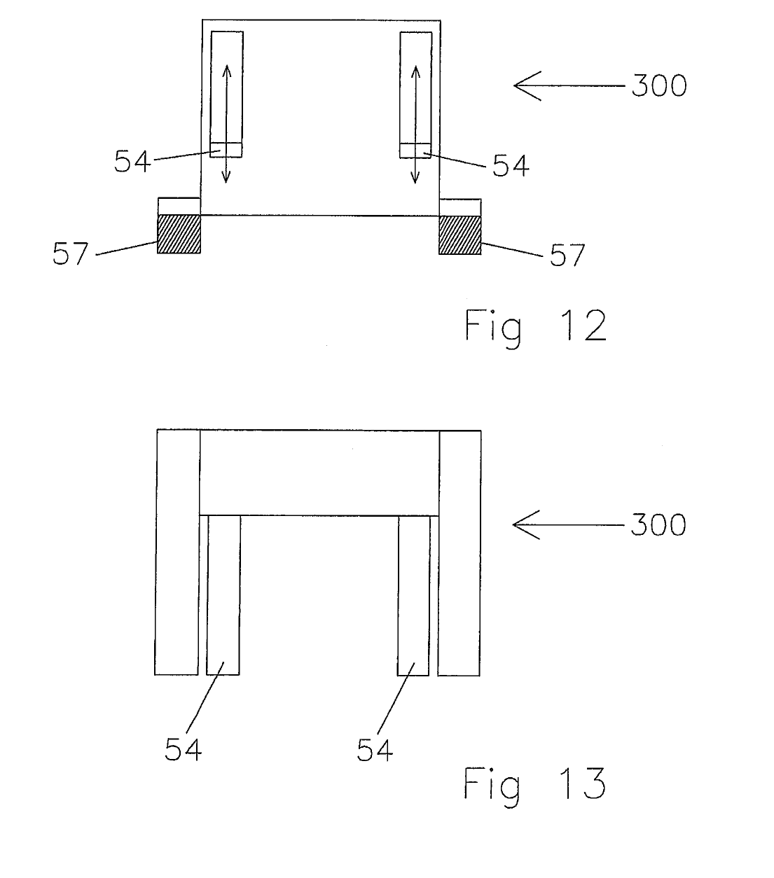

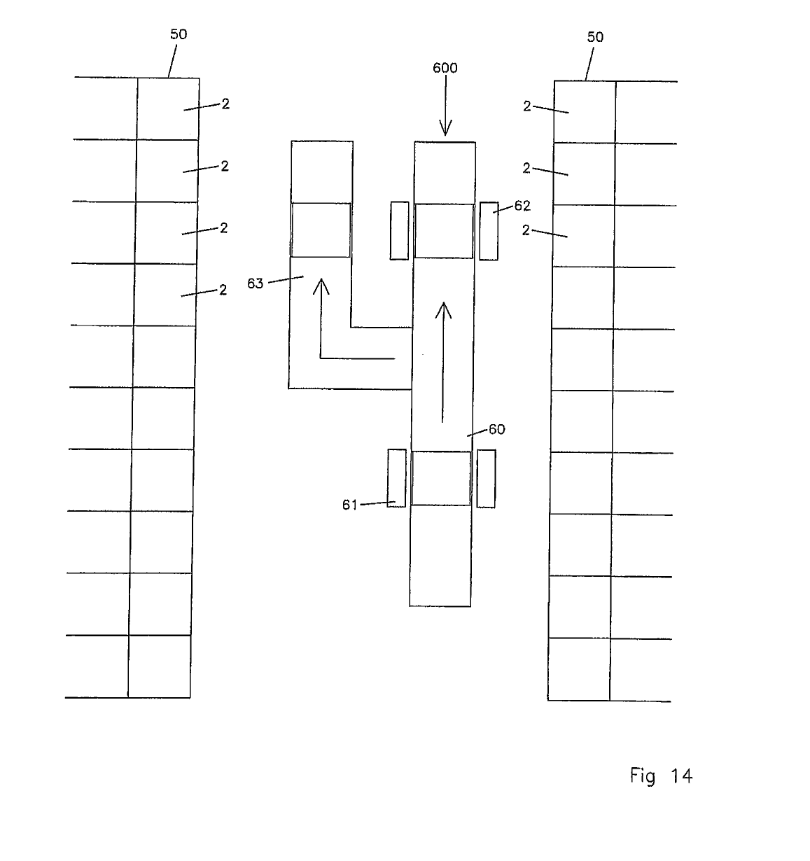

Any of the AGC designs described above may be used with the system of the present invention. However, in a preferred embodiment, as shown in FIGS. 12 and 13, the AGCs 300 are provided with lifting means such as tines 54 which engage a lower surface of the base of the lowermost container in a stack, as is shown in FIG. 11. This type of engagement can be performed relatively easily, without the need to position the AGC as accurately as would be necessary if it were required to engage with a slot or to grasp the sides of the containers. A further advantage is that containers with relatively low lateral strength (such as bread containers) can be engaged without the possibility of damaging the side walls of the container.

In the embodiment shown the AGC 300 is as “straddle” type, being of a substantially “U” shape when viewed from above, with wheels 57 provided at the ends and the base of the “U”. The tines 54 are provided inside the legs of the “U” shape. Straddle type AGCs of this general configuration are known those skilled in the art.

The AGCs are preferably of the “line following” type, such as are known to those skilled in the art.

### Replenishment of Carousel

Referring next to FIGS. 3, 6 and 7 and, as is described above, replenishment of the carousel 20 preferably utilises the stack configuring subsystem to supply destacked containers for storage in the carousel 20.

This process requires the stack configuring subsystem 102 to receive stacks which contain the required containers. While some reordering of the containers in a given stack can be done by the stacker/destackers 400 (as described above), it is preferred that the stack configuring subsystem 102 receives stacks which have the required containers arranged in substantially the correct order. This allows the carousel 20 to be replenished quickly with a large variety of products using much fewer stacker/destacker units 400 than there are varieties of product.

In a preferred embodiment a portion of the bulk storage area 10 is designated as a replenishment container storage zone 500 for storing and processing containers which are required for replenishing the carousel 20, as best seen in FIG. 14.

In the embodiment shown, this area comprises a plurality of racks 50 of substantially the same design as is described above with reference to FIG. 11, but storing the stacks on a single level, rather than two levels. In one embodiment the racks 50 are adapted to store 80 stacks of containers, with sufficient empty space provided on the racks for at least one additional row of stacks. The empty space allows stacks at the front of a rack to be moved out of the rack and stored when stacks at the rear of the rack need to be accessed. Each stack 2 contains only one type of item, and there is usually only one stack (or partial stack) of each variety of item stored in the zone 500.

A replenishment zone stack configuring apparatus 600 is provided inside the replenishment zone 500. The apparatus 600 comprises a first conveyor 60 which is provided with a container destacker 61. Those containers which are required by the stack reconfiguring subsystem move from the destacker 61 along the first conveyor 60 to a container stacker 62, where they are combined with containers containing other varieties of product, before being transferred as a full stack to the stack reconfiguring subsystem 102. In this way, stacks of containers can be prepared which contain the containers required to replenish the carousel 20, in the required order for entry into the stack reconfiguring subsystem 102.

A second conveyor 63 is provided which can receive containers from the destacker 61 which are not required by the stack reconfiguring subsystem 102. A second container stacker (not shown) may be provided at the end of the second conveyor 63, to re-stack the unwanted containers, ready for replacing them back in the racks 50, or the destacker 61 may be capable of releasing the remaining containers all together as a partial stack. If there are no containers left over from the stack (or partial stack) which enters the destacker, then a new stack of that variety of product may be moved from the main storage area 10 to the replenishment container storage zone 500.

In another embodiment (not shown) the replenishment zone stack configuring apparatus may comprise a flat support surface adapted to support a required number of stacks of containers, for example 80 stacks, arranged in 8 rows of 10 stacks. A first conveyor is provided parallel and adjacent to one side of the support surface, and a second conveyor is provided parallel and adjacent to an opposite side of the support surface. A pushing means is provided to push one or more stacks of containers from the first conveyor onto the support surface, thereby pushing an equal number of stacks of the support surface onto the second conveyor.

A third conveyor is provided which allows stacks of containers to travel directly from the second conveyor back to the first conveyor.

The second conveyor has a destacker for stacks containing containers which are required by the stack configuring subsystem. A fourth conveyor is provided which allows containers to travel from the destacker back to the first conveyor via a further stacker, so that the containers are configured back into a partial stack before being transferred to the first conveyor. At least one container stacker is provided at the end of the second conveyor.

Using this equipment the stacks of containers on the support surface can be cycled in a loop around the support surface, the second conveyor, the third conveyor, and first conveyor, until a stack of the required type is on the second conveyor. A required number of containers from this stack are moved to the stacker at the end of the second conveyor, while those containers not required are reconfigured into a partial stack by the stacker on the fourth conveyor and are returned to the support surface.

In a preferred embodiment a still further stacker is provided at the end of the second conveyor. The two stackers operating together allow stacks to be created which have the containers in a different order to that which they arrived at the first stacker. In a still further embodiment an AGC with a meshing gripping means may be used, which is capable of combining containers and partial stacks together to form a new stack of containers. In this embodiment the replenishment zone stack configuring apparatus 600 may not be required, as the AGC(s) are capable of creating suitable stacks for replenishing the carousel. If meshing gripper AGCs are used then the stacks may be stored on the floor, rather than in a rack.

### Delivery State Stack Creation

Referring back to FIGS. 3 and 7 in particular, when all the unit pick item stacks 29 for a given delivery vehicle have been prepared and stored, the system 100 moves to the second phase of operation wherein it creates delivery state stacks in the correct order to sending to the staging area 5.

The destackers 41 receive stacks of containers from the storage area 10. The stacks are preferably transported by the AGCs. The stacks presented to the destackers 41 are either a homogeneous stack, or a unit pick item stack 29.

The container destackers 41 feed the containers onto the main conveyor 40 at intervals which allow container stackers 42 at the opposite end of the conveyor 40 to create stacks of containers which are in a “delivery state”, that is, which are suitable for storing in the staging area 5 without any further reconfiguration. In preferred embodiments the unit pick item stacks 29 tend to enter the system through a destacker 41 which is close to the first end 40a of the main conveyor 40, in order to maximise the options for positioning the unit pick containers 28 within the delivery state stack created, while maximising the speed of the system.

One or more of the container stackers 42 at the second end of the main conveyor may be configured to operate as a container stacker/destacker, so that it can be utilised to reconfigure stacks (for example stacks of unit pick item containers), prior to configuration of delivery state stacks.

AGCs transport the delivery state stacks from the stackers 42 to the staging area 5, from where they are loaded into a delivery vehicle, as is described above.

### Further Embodiments

### First Phase

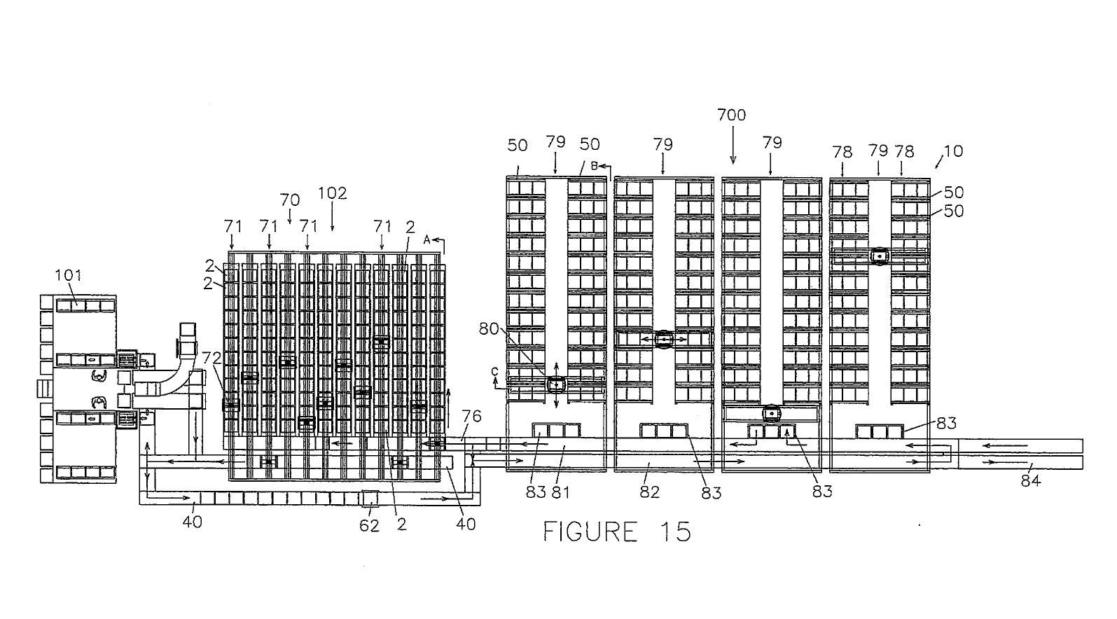

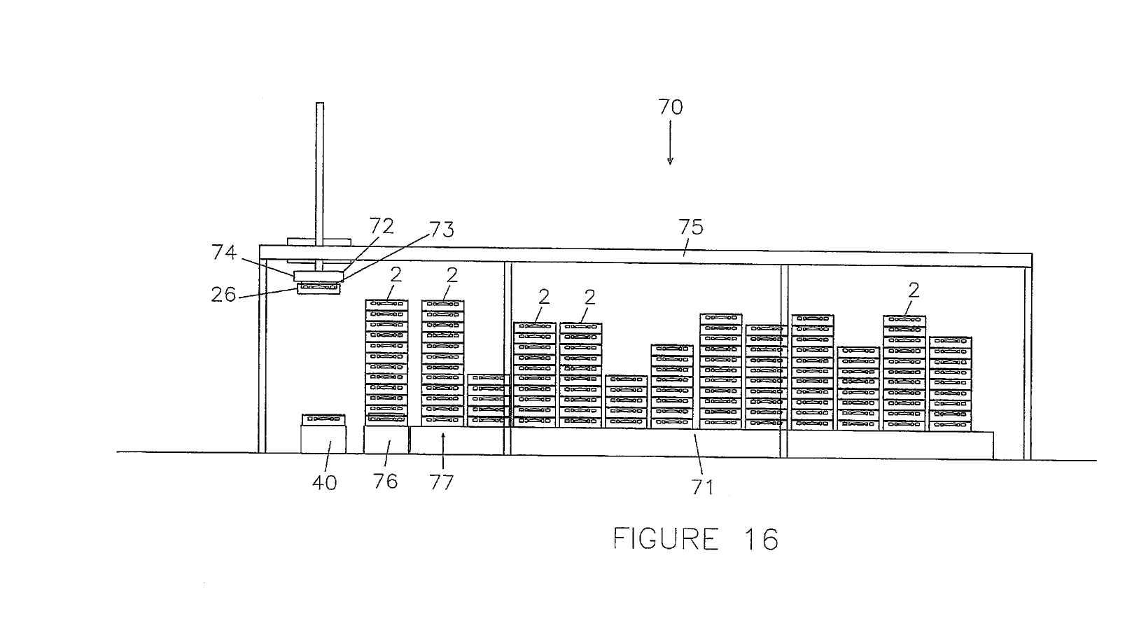

Referring next to FIG. 15, an alternative embodiment of the system is generally referenced by arrow 700. In this embodiment the picking subsystem 101 is substantially unchanged from the embodiments described above. However, the stack configuring subsystem 102 and storage areas 10 have been modified.

In the embodiment shown in FIGS. 15 and 16 the stack configuring subsystem 102 comprises a stack configuring subsystem storage area 70 comprising a plurality of conveying means extending transversely from the main conveyor 40. The conveying means preferably comprise a conveyor 71 of the endless belt or powered roller type. The number and length of the conveyors 71 is selected such that there is sufficient space on the conveyors 71 to accommodate a single homogeneous stack of all, or substantially all, of the different varieties of product. Each of the conveyors 71 may comprise a plurality of individually operable conveyor segments (not shown), or a single conveyor, as is described further below. In some embodiments the conveyor may comprise an endless belt type arrangement, while in other embodiments the containers may rest on spaced apart support rails described further below), and may be moved along the rails by one or more bogies which are provided beneath and between the spaced apart rails.

At least one gantry style robot 72 is provided for selecting crates from the stacks 2 in the stack configuring subsystem storage area 70. In the embodiment shown the stack configuring subsystem 102 has a separate robot 72 allocated to each conveyor 71, but in other embodiments each robot 72 may be operable to service two adjacent conveyors 71, or a plurality of conveyors 71. In some embodiments only a single robot 72 may be required to service all of the conveyors in the stack configuring subsystem storage area 70.

Each robot 72 is provided with a container engaging means, for example a gripper 73, which is adapted to allow the robot 72 to engage with the topmost container in a stack, and to lift the crate 26 from the stack 2. The robot 72 may then move the selected container 2 to the main conveyor 40. In preferred embodiments the robot 72 may lift the selected container over any stacks 2 between the selected stack and the main conveyor 40, but in other embodiments (not shown) an aisle may be provided between the conveyors 71 for the robot head 74 to move along. In one embodiment (not shown) the main conveyor 40 may be elevated above the height of a full stack, in order to reduce the vertical downward movement involved in setting the container onto the main conveyor 40, having lifted the container over the other stacks 2 in the stack configuring subsystem storage area.

As is best seen in FIG. 16, the robot 72 is preferably a gantry style robot which runs along an elevated rail 75. In the embodiment shown, the robot 72 is a two axis robot.

The stack configuring subsystem storage area 70 is replenished by a dedicated replenishment conveyor 76. The replenishment conveyor 76 extends substantially parallel to the main conveyor 40, and is located either between the main conveyor 40 and the stack configuring subsystem storage area 102 (if on the same level) or below the main conveyor 40 if the main conveyor 40 is elevated, as described above.

The replenishment conveyor 76 conveys full stacks of containers to the stack configuring subsystem storage area 70 to replace stacks 2 which have been completely depleted. In a preferred embodiment the new stack is transferred onto the appropriate stack configuring subsystem conveyor 71 by means of a pusher or similar, without involvement by the robot 72. This frees the robot 72 to operate solely to select containers for placement on the main conveyor 40. Of course, those skilled in the art will appreciate that the robot 72 may be operated to move containers or stacks of containers from the replenishment conveyor 76 to the stack configuring subsystem storage area 70 if required.

When a stack 2 of containers in the stack configuring subsystem storage area 70 is completely depleted (that is, the relevant robot 72 has removed the last container from the stack), the conveyor 71 (or conveyor segments) move any stacks 2 located between the vacant position and the main conveyor 40 away from the main conveyor 40, until the vacant space has been filled. If only a single conveyor 71 is used for each row of stacks 2, rather than individual conveyor segments being provided for each stack location in the stack configuring subsystem storage area storage area 70, then moveable mechanical stops (not shown) may be provided to prevent containers on the far side of the vacant space from moving further along the conveyor 71 when the conveyor is in operation. In other embodiments the conveyor 70 may be provided with a single static stop at the distal end, and the stacks 2 may be simply allowed to accumulate at the far end of the conveyor 71.

The stack configuring subsystem storage area replenishment method described above has the effect that new stacks of containers are always stored in the position 77 closest to the replenishment conveyor and the main conveyor 40. In this way stacks of seldom selected varieties of product tend to migrate to the positions further away from the replenishment conveyor and the main conveyor 40, while stacks of frequently selected product tend to accumulate in the spaces closest to the replenishment and main conveyors 76, 40. This in turn tends to increase the overall speed of the system, since the distance travelled by the robot 72 is minimised due to the centralisation of the frequently used containers.

During the first phase of operation the robots 72 select individual containers 26 of product necessary to replenish the unit picking subsystem 101, and the selected containers travel down the main conveyor 40 to the unit picking subsystem 101 where they are integrated into the carousel 20 in the manner previously described.

This embodiment of the system 700 obviates the need for a separate replenishment zone stack configuring apparatus.

Full unit pick item containers are dispatched from the unit picking subsystem 101 to the main conveyor 40, where they are integrated into full stacks by a container stacker 62.

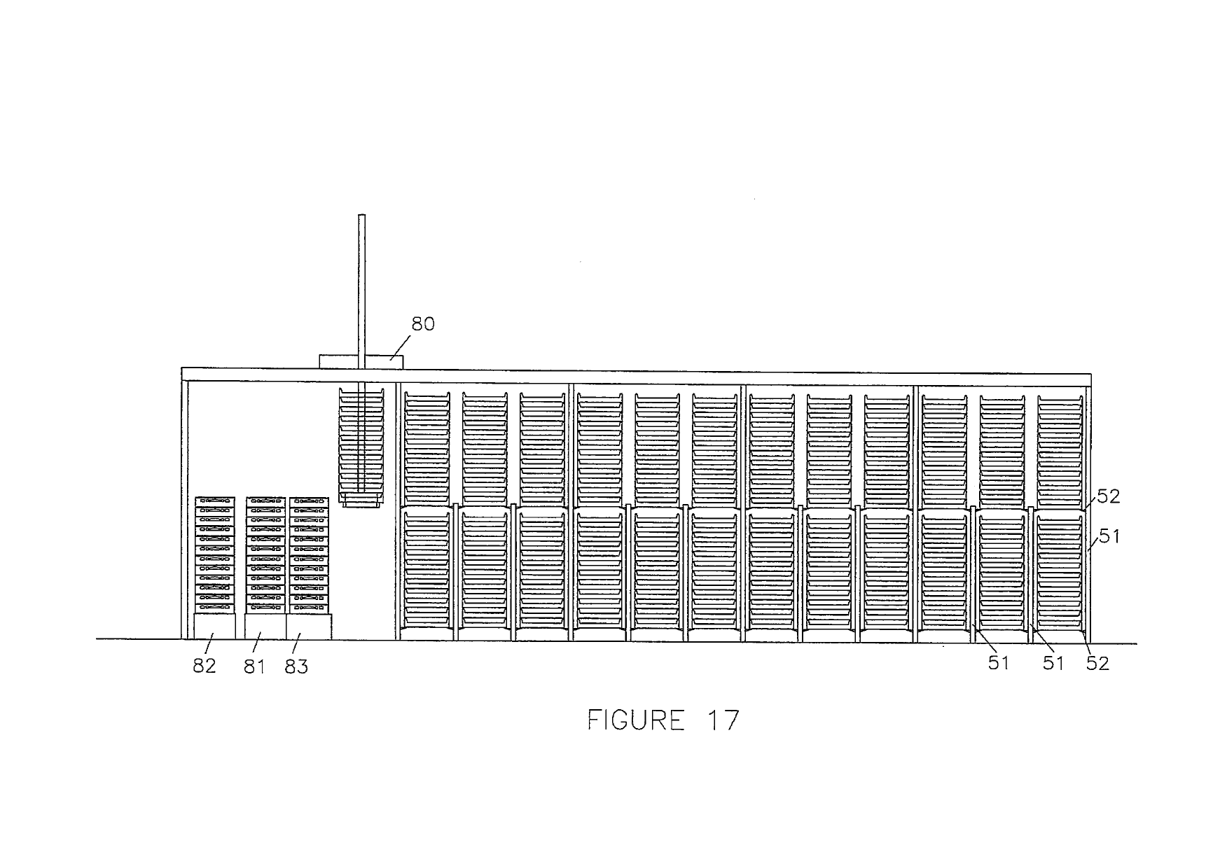

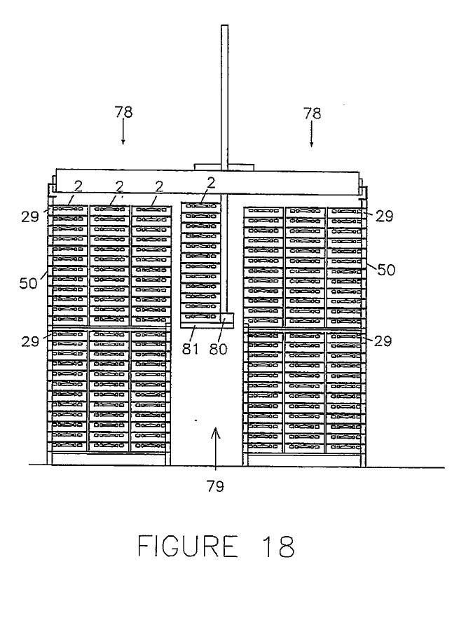

Referring next to FIGS. 15, 17 and 18, full unit pick item containers are sent from the unit picking subsystem 101 to the main conveyor 40. The main conveyor 40 is provided with a container stacker 62 which stacks the individual unit pick item containers into a stack. The stack is then transferred to a modified main storage area 10.

The main storage area 10 comprises a plurality of racks 50. The racks 50 are grouped into parallel rows 78 of racks 50 with an aisle 79 between each pair of rows. The racks 50 are adapted to hold stacks of containers on two levels, as with the embodiment shown in FIG. 11.

A three axis gantry robot 80 is provided for each aisle 79. The robot 80 is adapted to move stacks 2 of containers, and is preferably provided with a flat plate 81, a fork arrangement or similar, for engaging the base of the lowermost container in the stack 2. The robot 80 is moveable along three axes, in order to allow access to stacks 2 stored at the back of a rack 50. The plate 81 is rotatable about a vertical axis to any one of four positions, when carrying a stack or when empty.

As with the AGC based system described above, the robot 80 can only access stacks of containers 2 stored on the lower level towards the back of a rack 50, if the upper level of the rack 50 is clear.

First and second storage area conveyors 81, 82 are provided which extend along one side of the storage area 10. In the embodiment shown, the conveyors 81, 82 extend substantially orthogonally to the aisles 79. The first and second conveyors 81, 82 operate in opposite directions, with the first conveyor 81 (being the conveyor nearest the ends of the aisles) moving towards the stack configuring subsystem 102. A pushing mechanism (not shown) is provided at both ends of the conveyors 81, 82 so that containers or stacks can be made to travel along one conveyor 81, 82 and then back along the other conveyor 81, 82 as many times as is required.

The stack of containers from the stacker 62 moves down the second conveyor 82, is pushed onto the first conveyor 81, and then moves down the first conveyor 81 until it reaches a position adjacent the aisle 79 associated with the rack 50 in which the stack is to be stored.

When stacks are received for storage in the main storage area 10 (whether from the picking subsystem 101 or from a production zone (not shown)) they move along until they are pushed by a pushing mechanism (not shown) off the first storage area conveyor 81 and onto an adjacent buffer conveyor 83 provided at the end of the aisle 79. The buffer conveyor 83 is parallel to the first storage area conveyor 81 and is typically only long enough to hold a relatively small number of stacks, for example three stacks. The stack to be stored waits on the buffer conveyor 83 until it is picked up by the robot 80 and placed into a vacant area in a rack. A second pusher (not shown) is provided for pushing stacks from the buffer conveyor 83 to the first storage area conveyor 81 during the second phase of operation, as is described further below. Use of the buffer conveyor 83 allows the first and second conveyors 81, 82 to be operated continuously without the requirement for the robot 80 to be available to remove the stack from the first conveyor 81 as it moves past the aisle 79. However, in some embodiments the robot 80 may be operable to pick stacks directly from the conveyor 81 and/or may be operable to place stacks directly onto the conveyor 81, whether or not a buffer conveyor 83 is used.

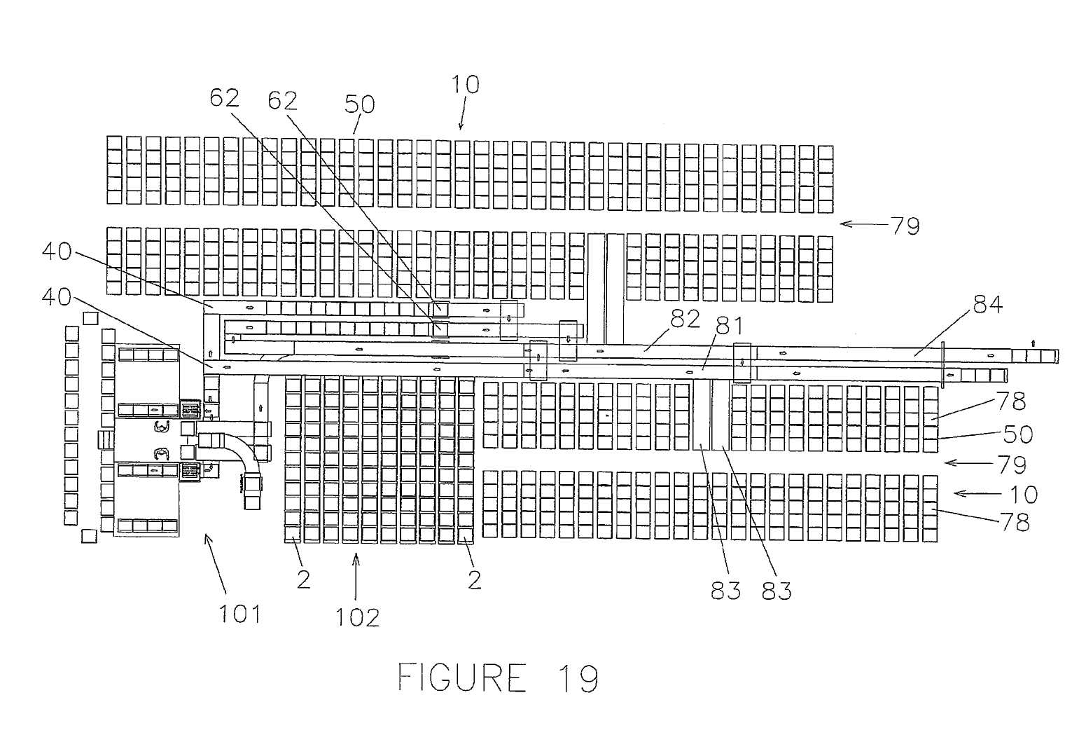

In another embodiment, shown in FIG. 19, the aisle(s) 79 may extend substantially parallel to the first and second storage area conveyors 81, 82. One or more buffer conveyors 83 may be provided to transport stacks between the first conveyor 81 or second conveyor 82 to a point inside the storage area and adjacent the aisle 79, and back again.

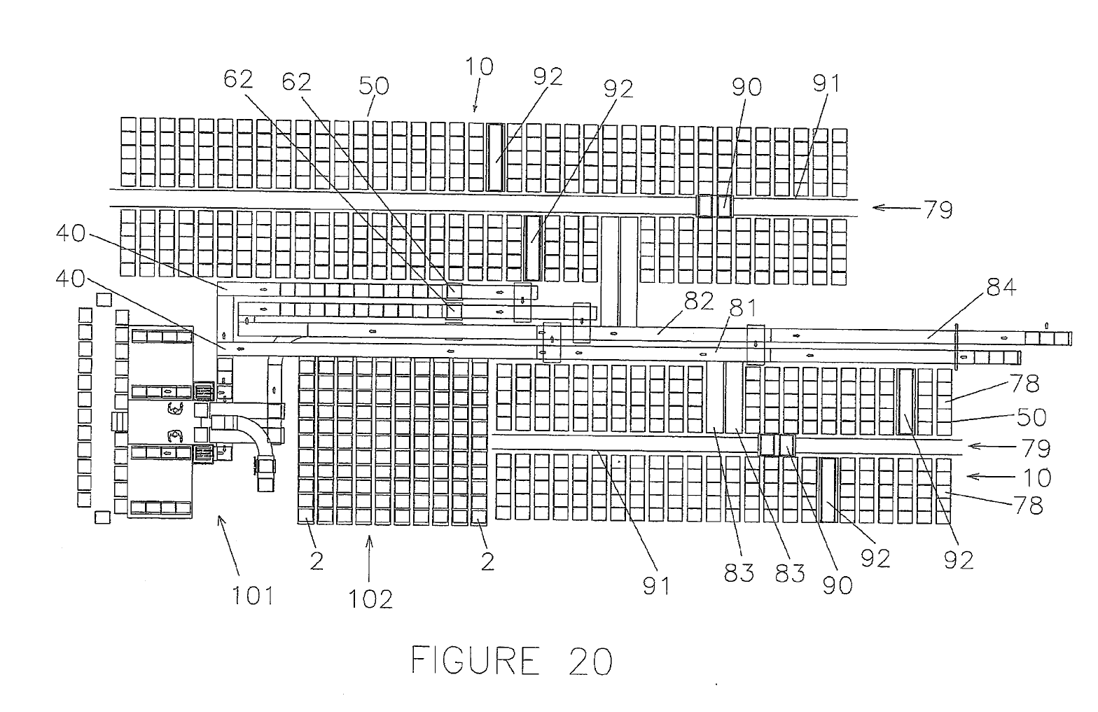

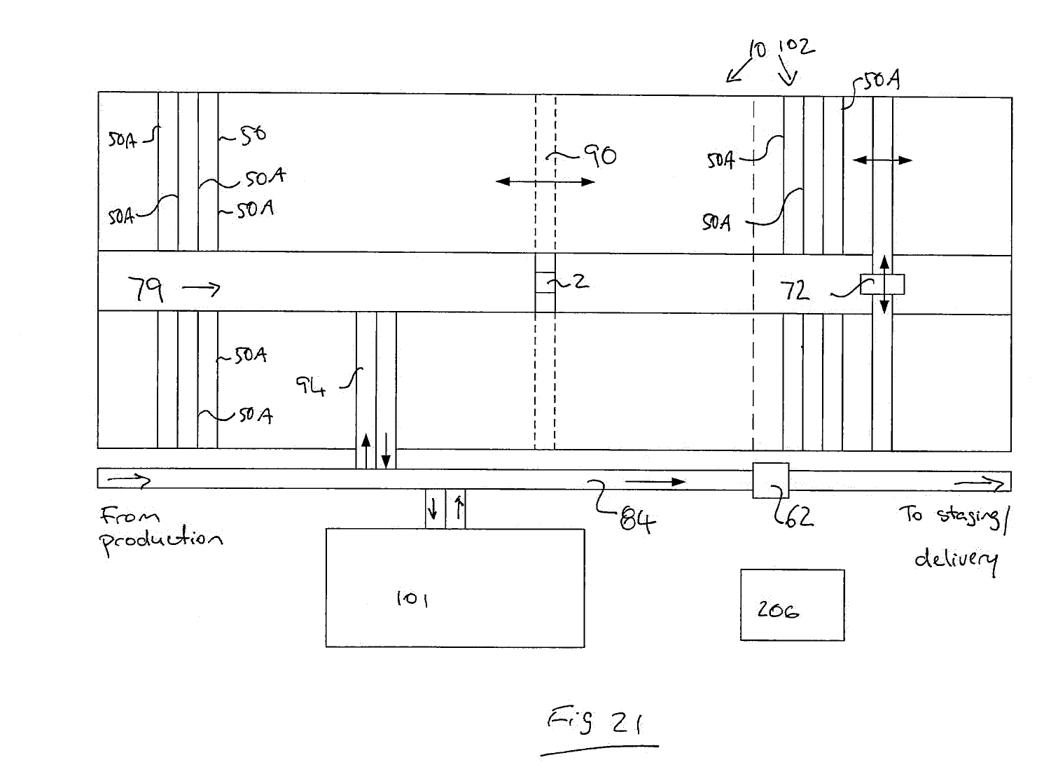

Referring next to FIG. 20, a variation of the embodiment shown in FIG. 19 is shown.

In this embodiment each aisle 79 of the storage area 10 is provided with a moveable conveyor 90. The moveable conveyor 90 is preferably orientated so as to be substantially parallel to the racks 79, so as to be able to load containers on and off the racks 79. The entire conveyor 90 is itself moveable in a transverse direction to the racks, so that the conveyor (and any containers or stacks located on the conveyor) can be indexed with any selected rack, or with one of the buffer conveyors 83. In a preferred embodiment the conveyor is supported on wheels which are engaged with rails 91.

The moveable conveyor 90 is preferably sufficiently long to accommodate more than one stack, for example it may accommodate two or three stacks. The moveable conveyor may comprise two or more parallel conveyor segments arranged side-by-side, in order to increase the carrying capacity of the moveable conveyor 90, and also to increase the options for changing the order in which the containers are loaded onto the buffer conveyors 83.

In one embodiment the racks 50 may be provided as elevated rails which are cantilevered at the opposite ends to the aisle 79, so as to provide a clear space beneath. A second moveable conveyor 92 may be provided underneath each row of racks 50. Each second moveable conveyor 92 may be able to move along beneath the row of racks, and then to elevate between the rails of a selected rack in order to engage the base of the stacks of containers in the selected rack, and to move those containers onto or off the moveable conveyor 90. In some embodiments the second moveable conveyors 92 may be carried by the same mechanism as the moveable conveyor 90 and so may always be aligned with the moveable conveyor 90, but in other embodiments they may have a separate support system, including a separate set of rails (not shown), and so may be moveable independently of the moveable conveyor 90. In another variation the racks 50 may be replaced by a plurality of individual storage conveyors (not shown) on which the containers can be stored (in a manner similar to conveyors 71 in the stack configuring subsystem storage area).

The racks 50 or storage conveyors may be arranged on a single level, or more preferably on two or more levels (not shown), one above the other, with each level being provided with a separate moveable conveyor 90. Stack elevator means, for example a lifting platform (not shown), may be provided to lift stacks of containers destined for the upper levels from the first storage area conveyor 81 to the appropriate buffer conveyor 83.

The operation of the storage area shown in FIG. 20 is identical to that shown in FIG. 19, except that the containers are carried by moveable conveyor 90 rather than the gantry robot.

### Further Embodiments

### Second Phase

Referring back to FIGS. 15 to 18 in particular, in the second phase the stack configuring subsystem 102 places containers onto the main conveyor 40 in the correct order for the stacker 62 to produce delivery state stacks. The stack configuring subsystem 102 receives stacks of containers (including stacks of unit pick item containers) from the storage area 10, via the robot 80, buffer conveyor 83 and first storage area conveyor 81, as required.

The stack configuring subsystem 102 creates delivery state stacks by selecting containers from the stacks stored in the stack configuring subsystem storage area 70 and placing them onto the main conveyor 40 in the correct order for the stacker 62 to create delivery state stacks. The delivery state stacks move along the second storage area conveyor 82 to an outfeed conveyor 84. In a preferred embodiment a worker with a suitable trolley (not shown) or similar collects a plurality of delivery state stacks from the outfeed conveyor and transfers them into the delivery vehicle.

Alternative method—First Phase

In the first phase of the embodiments described above, containers are filled with picked items, and stacks of picked item containers which are all destined for the same delivery vehicle are stored in the storage area 10. This means that a full stack can only be transferred from the unit picking subsystem to the storage area 10 when all the products necessary to fill a full stack of unit pick item containers for a given delivery vehicle is available. Since the full stack of unit pick item containers may contain a large variety of products, and the products may not all be available until the production run is quite advanced, this may lead to a relatively long delay before picking can be commenced.

Referring back to FIGS. 15 to 18, in an alternative embodiment the system 700 may be operated in a different manner. Rather than only storing full stacks of unit pick item containers in the storage area 10, the system may also store intermediate state stacks which are a combination of unit pick item containers and homogenous variety containers, or stacks which consist only of homogeneous variety containers.

Each stack consists only of containers destined for a particular delivery vehicle, and the containers within the stack are in the correct relative order for the delivery sequence of that delivery vehicle (that is, each container in a stack is intended for the same or a later delivery than the container above it, or, each container in a stack is intended for the same or an earlier delivery than the container above it). This means that that delivery state stacks can be formed without using containers from the intermediate state stacks out of sequence.

Containers received into the system 700 in an initial state from the infeed conveyor are not stored in the storage area 10 by default. Rather, most containers from the infeed conveyor are sent to the stack reconfiguring subsystem 102 and are stored in the stack configuring subsystem storage area 70.

Stacks for storage in the storage area 10 may be a) full stacks of unit pick item containers, b) full stacks of homogenous variety containers from the stack reconfiguring subsystem (or possibly directly from the infeed conveyor), or c) a combination of unit pick item containers and homogenous variety containers from the stack reconfiguring subsystem 102. Stacks which are a combination of unit pick item containers and homogenous variety containers are formed by inserting unit pick item containers into a sequence of homogeneous variety containers as they travel along the main conveyor 40.

In some cases initial state containers may by chance be received into the system from the infeed conveyor in a stack which is suitable for storage in the storage area without first being re-ordered by the stack reconfiguring subsystem 102. In these cases the stack is simply diverted directly into the appropriate part of the storage area. Some other stacks of containers may be temporarily held in a different part of the storage area 10 as a “buffer” supply until sufficient additional varieties of product have been produced to begin making stacks for storage in the storage area 10.

All stacks formed during the first phase which are destined for delivery by the same delivery vehicle are grouped together within the storage area 10. This promotes efficient use of the storage capacity of the storage area, and in particular, avoids the need to move unwanted stacks from the front of a rack 50 in order to gain access to stacks behind.

### Alternative Method—Second Phase

By the time the second phase begins, all of the containers required to fulfil all the orders for a particular delivery vehicle have been stored together in the storage area 10. All that is required is to use the stored stacks, which are in the correct relative order, to create stacks which are in a delivery state.

The stacks for a particular delivery vehicle are transferred from the storage area 10 to the stack configuring subsystem storage area 70. The stack configuring subsystem 102 them creates delivery state stacks from the stacks in the storage area 10 in the manner previously described. Because all of the containers required for the delivery vehicle are contained in the stacks which have been transferred into the stack configuring subsystem storage area 70 from the storage area 10 (predominantly in full stacks), it is not necessary for the stack configuring subsystem storage area 70 to contain any additional containers. This means that the stack configuring subsystem storage area 70 can be made smaller than it would need to be for embodiments which require the stack configuring subsystem storage area 70 to store a stack of almost every different variety of product.

Because of the configuration of the intermediate state stacks, the stack configuring subsystem can create the delivery state stacks simply by selecting containers from the top of the intermediate state stacks stored in the stack configuring subsystem storage area 70, without the need to use any containers out of sequence (that is, without having to remove a container from a stack simply to access a lower container in the stack).

### Further Alternative Method for Operating Alternative Embodiment

Referring next to FIG. 15, the system may be operated differently. Rather than operate the system in two phases, the main storage area may be enlarged so as to be have capacity to store most of the day's production.

Once a sufficient quantity of product has been stored in the main storage area 10, delivery state stacks may be created directly by moving the required stacks and individual containers from the main storage area 10 and stack configuring subsystem storage area 102 to the main conveyor 40.

The stack configuring subsystem storage area 102 is replenished with full stacks of containers as necessary to ensure that the stack configuring subsystem storage area 102 always contains at least one container of each variety of product. The stack configuring subsystem storage area 102 is typically replenished by moving a single full homogeneous stack of containers from the main storage area 10 to the stack configuring subsystem storage area 102, although in some embodiments the stack configuring subsystem storage area 102 may be replenished with a full homogeneous stack of containers which is received directly from a production area (not shown).

Delivery state stacks are created by transferring a required number of full homogenous stacks from the main storage area 10, a required number of individual containers from the stack configuring subsystem storage area 102, and a required number of unit pick containers from the unit pick subsystem 101. The containers are stacked into full stacks by the container stacker 62. In this embodiment the container are sent from the container stacker 62 to the staging area and/or delivery vehicle.

Those skilled in the art will appreciate that operating the system in this manner requires the system to operate in a more intensive manner than the previously described methods of operation, and may require container handling equipment which operates at higher speeds and/or is otherwise capable of higher throughput.

The systems shown in FIGS. 19 and 20 may also be operated in this way, with the main storage area 10 storing most or all of the product generated in one cycle (for example one day), and then delivery state stacks created by transferring full homogenous stacks, as required, from the main storage area 10, one or more individual containers from the stack configuring subsystem storage area 102, and unit pick containers from the unit pick subsystem 101. The containers are stacked into full stacks by the container stacker(s) 62.

### Additional Embodiments

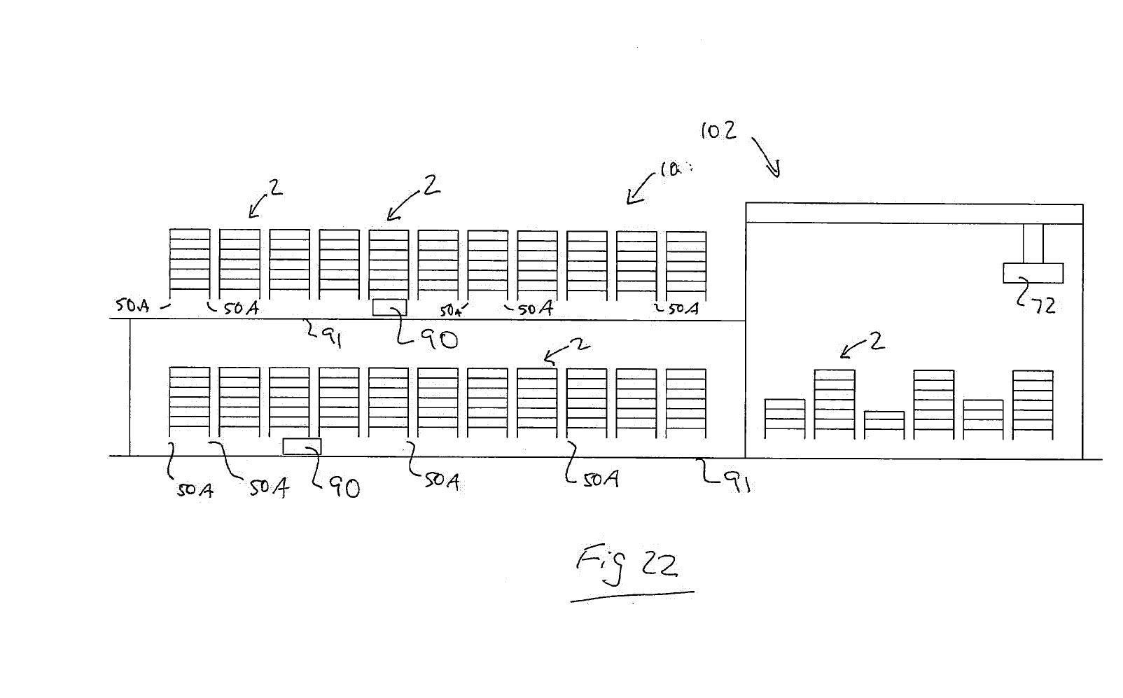

Referring next to FIG. 21, a further embodiment of the invention is described which operates in a similar manner to those described immediately above.

In this embodiment the main storage area 10 and the stack configuring subsystem storage area 102 are directly adjacent. The stack configuring subsystem storage area 102 is preferably defined by the area which a gantry style robot 72 (or a plurality of gantry style robots) is able to access, but is not otherwise physically separated from the main storage area. The gantry style robot 72 is preferably a three axis robot, although a plurality of two axis robots may be used.

The main storage area 10 and the stack configuring subsystem storage area 102 preferably comprise racks 50 which are provided as elevated support members, for example rails 50A, which are cantilevered at opposite ends to a central aisle space 79 so as to provide a clear space beneath the racks 50 for a moveable conveyor 90. The moveable conveyor 90 is able to move transversely to its longitudinal axis to be positioned beneath any selected row of racks 50, and then to elevate between the rails of a selected rack 50 in order to engage the base of the stacks of containers in the selected rack. Once engaged the containers can be moved along the length axis of the conveyor 90, for example to a different position on the rack 50, or into the aisle space 79. Containers or stacks of containers which are positioned in the aisle space 79 can be moved along the aisle space 79 by the moveable conveyor 90. In a preferred embodiment the aisle space is wide enough for two, three or more stacks of containers to be transferred down the aisle 79 at once.

In some embodiments a plurality of moveable conveyors 90 are provided. The conveyors 90 may all run on the same support rails, or there may be multiple sets of support rails, so that at least one of the conveyors 90 can move past the other if required.

In the embodiment shown in FIG. 21, homogeneous stacks of containers can be transferred directly from the main storage area 10 to the second storage area 102 by the moveable conveyor 90, without the need to travel on any additional conveyors.

In one embodiment the gantry robot 72 selects one or more containers from the containers in the second storage area 102 and places them on the moveable conveyor 90, for transfer to the main or outfeed conveyor 84. However, in other embodiments the gantry robot 72 may place the selected container(s) directly onto the main or outfeed conveyor 84, or onto an intermediate conveyor (not shown) which transfers the container(s) to the main or outfeed conveyor 84. In preferred embodiments the robot 72 is used to move selected containers out of the second storage area 102, but not to move stacks or containers into the second storage area 102.

A unit picking subsystem 101, for example as is described above, may also be provided to supply containers of unit pick items.

Delivery state stacks are created by transferring full homogenous stacks, as required, from the main storage area 10, one or more individual containers from the stack configuring subsystem storage area 102, and unit pick containers from the unit pick subsystem 101. The containers are stacked into full stacks by the container stacker 62. In preferred embodiments the stacker 62 receives the containers in the correct order to stack them into delivery state stacks.

Containers may be received into the main storage area by any suitable means. In the embodiment shown in FIG. 21 the main storage area 10 is provided with a delivery conveyor 94 and a dispatch conveyor 95 for transferring containers into and out of the main storage area 10.

Referring next to FIG. 22, in one embodiment the system shown in FIG. 21 the main storage area 10 comprises two tiers, a lower tier and an upper tier provided directly above the lower tier. Stack elevator means, for example a lifting platform, may be provided to elevate lift stacks of containers destined for the upper tier to the correct level.

Variations of the embodiment shown in FIGS. 21 and 22 are possible. For example, in some embodiments the containers in the main storage area 10 and/or the stack configuring subsystem storage area 102 may be stored on individual conveyors, rather than on spaced apart rails 50A. In this embodiment the moveable conveyor 90 does not extend below the stored containers or stacks, but is still above to move up and down the aisle space 79.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the invention.

1. A system for storing and retrieving a plurality of varieties of containers comprising:
a main conveyor;
a main storage area for storing full stacks of containers;
conveying means for moving stacks of containers from the main storage area to the main conveyor;
a second storage area for receiving full stacks from the main storage area, the second storage area configured to accommodate a stack of each variety of product;
a gantry robot adapted to select one or more containers from any stack of containers stored in the second storage area;
wherein the main conveyor is provided with a container stacker for stacking containers received from the gantry robot into full stacks.

2. The system of claim 1 wherein the main storage area is provided with a plurality of parallel, spaced-apart, support members adapted to support a base of the stacks of containers, and one or more moveable conveyors engageable with one or more containers supported by the support members to transport it or them longitudinally, wherein said one or more moveable conveyors is moveable transverse to said support members below said support members to enable selective engagement with containers positioned on said support members.

3. The system of claim 1 wherein the spaced apart support members are arranged into two tiers, one of said tiers provided above the other.

4. The system of claim 1, wherein the main storage area comprises an aisle space and the support members are arranged perpendicular to a longitudinal axis of the aisle space.

5. The system of claim 4 wherein support members are provided on both sides of the aisle space.

6. The system of claim 4, wherein at least one of the moveable conveyors extends into the aisle space so as to be able to transport at least one stack of containers along the aisle space.

7. The system of claim 1 wherein the second storage area is provided with a plurality of parallel spaced-apart second storage area support members adapted to support a base of the stacks of containers.

8. The system of claim 7 wherein one or more second storage area moveable conveyors are provided which are engageable with one or more containers supported by the second storage area support members to transport it or them longitudinally, wherein said one or more second storage area moveable conveyors is moveable transverse to said second storage area support members below said second storage area support member to enable selective engagement with containers positioned on said second storage area support members.

9. The system of claim 8 wherein the second storage area comprises an aisle space and the second storage area support members are arranged perpendicular to a longitudinal axis of the aisle space.

10. The system of claim 9 wherein the second storage area support members are provided on both sides of the aisle space.

11. The system of claim 8 wherein at least one of the moveable conveyors of the second storage area extends into the aisle space so as to be able to transport at least one stack of containers along the second storage area aisle space.

12. The system of claim 1 wherein the second storage area aisle space is connected to the aisle of the main storage area.

13. The system of claim 12 wherein the second storage area aisle space is collinear with the aisle space of the main storage area.

14. The system of claim 1 wherein the second storage area is adjacent the main storage area.

15. (canceled)
